(19) United States
(12) Patent Application Publication
(10) Pub. No.: US 2005/0119908 A1
(43) Pub. Date: Jun. 2, 2005

(54) Systems, methods, and computer program products for managing real estate transactions

(76) Inventors: Russell H. Hippe, Atlanta, GA (US); Jon M. Shibley, Roswell, GA (US)

Correspondence Address: William R. Silverio;SUTHERLAND ASBILL & BRENNAN LLP, 999 Peachtree Street, NE, Atlanta, GA, 30309-3996, US

(21) Appl. No.: 10/926,213

(22) Filed: Aug. 25, 2004

Related U.S. Application Data
(60) Provisional application No. 60/527,346, filed on Dec. 5, 2003.
(60) Provisional application No. 60/497,685, filed on Aug. 25, 2003.

(51) Int. Cl. G06F 17/60

(52) U.S. Cl. 705/1

(57) ABSTRACT

Multiple parties to a real-estate transaction may access, view, upload and/or download documents related to the transaction via a connection to an Internet server. The multiple parties may have varying levels of access to transaction information based on the identity of a party. Because all information related to a transaction is located online, each party has up-to-date information regarding the status of a loan as well as access to loans documents, thereby significantly decreasing the time and expense required to process a loan. One or more check lists and caveat checks may automatically assess transaction information to eliminate the potential for fraud and the improper processing.

### RELATED APPLICATION DATA

The present application claims priority to U.S. Provisional Patent Application No. 60/527,346, filed Dec. 5, 2003, titled “Systems, Methods and Computer Program Products For Managing Real Estate Lending”, and U.S. Provisional Patent Application No. 60/497,685, filed Aug. 25, 2003, titled “Systems, Methods and Computer Program Products For Managing Real Estate Loans”, the contents of each of which are incorporated by reference as if set forth fully herein.

### FIELD OF THE INVENTION

The present invention generally relates to a software application for managing the day-to-day details of real-estate loans. More specifically, the present invention relates to systems, methods and computer program products for managing real-estate closings where loan officers and other parties, such as title companies, may input information and manage documents relating to the loan, and follow the progress of a loan from the title request to post-closing transactions.

### BACKGROUND OF THE INVENTION

Thousands of real estate loan transactions occur everyday in the United States. Real estate loan transactions are document intensive, and require the participation of many individuals, including buyers, sellers, agents, lenders, loan officers (e.g., attorneys), brokers, and title companies. Typically, many of these individuals must communicate with each other to obtain documents necessary to process and complete a loan transaction. Because much of this information is exchanged via telephone, faxes and email, the process may move slowly when individuals or entities are unable to obtain requisite information quickly. Additionally, errors often occur because information is not readily available, documents are handled by hand, and processes are not automated.

In most real-estate lending transactions information about the buyer, seller, property and related parties must be collected and disseminated to interested parties. This may include information such as: the buyer's name, address and contact information, lender name, address and contact information; property city/county tax and title information; buyer loan information (e.g., credit reports, insurance, etc.), loan officer identity, address, and contact information, lending-related information, and like information. Managing this information can be difficult because of the number of parties involved and the order in which information is received from parties and processed. Delay in receiving one document can result in substantial delays to the entire process.

As an example, in a typical real-estate closing process, a lender works with a closing attorney or title agency to have a title search performed on the property by a title search company to determine if there are any liens or encumbrances on the property. Lenders also typically require that title insurance be obtained on the title search prior to closing. Therefore, a delay in receiving and transmitting the title search to interested parties can delay the closing process. An error in the processing of such an item can also result in significant losses to parties such as the real-estate attorney handling the closing. Additionally, fraudulent activity must be identified so as to minimize the risk to any party to the transaction.

Therefore, it will be appreciated that there is a need for a system that allows all parties to a loan to communicate effectively in order to minimize the time and expense of the closing process. There is also a need for a system that helps to minimize errors and identify fraud in the processing of real-estate transactions.

### SUMMARY OF THE PRESENT INVENTIONS

The present invention generally relates to a network accessible software application for managing real-estate closings, and methods and systems for using the same. The software application is preferably accessible by all users via a Wide Area Network (WAN) such as the Internet, although the application may also be accessible via Local Area Networks (LANs) or stand alone computers. In brief, the present invention permits multiple parties to a real-estate loan transaction to access, view, upload and/or download documents related to the real-estate loan. According to a preferred embodiment these features are accessible via a connection to an Internet server accessible by each party. Because multiple parties may access the software, the software permits varying levels of access to information based on the identity of a party, identified by a username and password or the like.

Users are provided with multiple, user-friendly Graphical User Interfaces (GUIs) for viewing and locating loans, their status and for displaying information relevant to a real-estate loan transaction. Because all information related to the loan is located online, each party to the loan has up-to-date information regarding the status of a loan as well as access to loans documents, thereby significantly decreasing the time and expense required to process a loan. The present invention also provides one or more check lists and caveat checks to eliminate the potential for fraud and the improper processing of a loan (e.g., where additional information is required before closing.)

According to one embodiment of the invention, multiple loans may be managed simultaneously by one or more loan officers, which may view GUIs that display information specific to each loan, including: the data agent identity, the date loan order was originated, the age of the loan order (e.g., in days), the customer name, one or more milestone fields presented by status icons (such as whether the title search is complete and downloaded) and a file number associated with each loan. There may also be one or more clickable icons, such as an email icon and a calendar icon, which permits a user with authorization to email individuals associated with the loan, or to open a loan management interface to update loan information. Furthermore, according to one aspect of the present invention, each of the above-identified fields are searchable and selectable. For instance, when a specific loan officer's name is selected, those outstanding loans associated with the loan officer may be displayed along with the remaining information specific to the loan. As another example, loans may be ordered based on their age or date. Clicking on a customer name may also permit the user to update customer information, as is explained in detail below with reference to the GUI descriptions.

As noted above, by clicking on one or more icons a user can initiate one or more processes. For example, when a title icon or box is selected the user may be provided a GUI from which a title search may be ordered. After inputting the requisite information, the system can automatically initiate a title search report by sending and email to a title searcher. Because the system maintains the record of the real estate at issue, the system can automatically forward such information to the title searcher. The system will then update the title icon to indicate that a title search was requested. The date of the request may also be stored. Therefore, the system fully automates a process that is otherwise more paper intensive and time consuming.

According to one aspect of the present invention, the status of a file may also be quickly ascertained by viewing status icons selected by a user to indicate the status of a loan: e.g., whether it is on hold, new, incomplete or complete. Additional features of the present invention permit a user to print all online information related to the loan, and to upload, download and print documents that have been scanned or saved in electronic form. For instance, according to one aspect of the present invention, faxes may be electronically received and automatically saved by the system, after which an operator or the system associates the faxed documents with one or more loans. A master report can be generated by filters based on file status (new, open, complete, closed and on hold), file number, and data agent. Multiple reports are also generated that track the daily progress of each data agent.

According to one embodiment of the present invention, there is disclosed a real-estate transaction management system. The system includes at least one server, on which a real-estate transaction application is stored, the real-estate transaction application accessible by one or more users and operable to: store transaction information related to a real-estate transaction, identify the status of the real-estate transaction using one or more updateable icons, and provide one or more interfaces by which the one or more users may view or edit the transaction information or updateable icons.

According to one aspect of the present invention, the real-estate transaction application is further operable to permit access by the one or more users via a WAN or LAN. The real-estate transaction application may also be operable to compare the transaction information to a caveat list to identify when the transaction information includes fraudulent information. The caveat list may be stored local or remote to the at least one server. According to another aspect of the invention, the real-estate transaction application is operable to receive transaction information provided by the one or more users. Additionally, the real-estate transaction application may be operable to display all or part of the transaction information to the one or more users based on respective access rights of the one or more users.

According to another embodiment of the present invention, a real-estate transaction management system is disclosed. The system includes at least one server, on which a real-estate transaction application is stored, the real-estate transaction application accessible by one or more users and operable to: store transaction information related to a plurality of real-estate transactions, wherein the transaction information is provided by one or more parties to the plurality of real-estate transactions, identify the status of the real-estate transactions to the one or more users, and provide a real-estate transaction management interface by which the one or more users can view the status of the plurality of real-estate transactions.

According to one aspect of the invention, the real-estate transaction application is further operable to permit access by the one or more users via the Internet. The real-estate transaction application may also be operable to compare the transaction information to a caveat list to identify when the transaction information may include fraudulent information. The caveat list may be local or remote to the at least one server. According to another aspect of the invention, the caveat list may include a property address or a purchaser name. Furthermore, the real-estate transaction management interface may illustrate the status of the plurality of real-estate transactions using one or more icons. The one or more icons may be selectable by the one or more users to facilitate the execution of a step to advance one of the plurality of real-estate transactions. Moreover, the real-estate transaction application may be operable to display the transaction information to the one or more users based on respective access rights of the one or more users.

According to yet another embodiment of the present invention, there is disclosed a method for managing a real-estate transaction. The method includes the steps of: collecting transaction information related to a real-estate transaction, the transaction information comprising a property address or a customer name, storing the transaction information, making the transaction information available to parties to the real-estate transaction via the Internet, storing a caveat list identifying fraudulent transaction information, and identifying when the stored transaction information includes fraudulent transaction information.

According to one aspect of the present invention, the caveat list may be local or remote from the transaction information. Additionally, the method may also include the step of updating the caveat information using information received from an entity not a party to the real-estate transaction.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating an exemplary system for implementing the invention, according to one embodiment of the present invention.

FIG. 2 is a block diagram illustrating an exemplary system in accordance with certain exemplary embodiments of the present invention.

FIG. 3A shows a log interface, according to an illustrative embodiment of the present invention.

FIG. 3B shows an informal site permission table, according to one illustrative embodiment of the present invention.

FIG. 4 shows a main menu interface interface, according to an illustrative embodiment of the present invention.

FIG. 5 shows a control panel interface, according to an illustrative embodiment of the present invention.

FIGS. 6 and 7 show a client modify interface, according to an illustrative embodiment of the present invention.

FIG. 8 shows an administrative control interface, according to an illustrative embodiment of the present invention.

FIG. 9 shows a new vendor interface, according to an illustrative embodiment of the present invention.

FIGS. 10 and 11 show a vendor list interface, according to an illustrative embodiment of the present invention.

FIG. 12 shows a group email interface, according to an illustrative embodiment of the present invention.

FIG. 13 shows an email list interface, according to an illustrative embodiment of the present invention.

FIG. 14 shows a county list interface, according to an illustrative embodiment of the present invention.

FIG. 15 shows a user information interface, according to an illustrative embodiment of the present invention.

FIG. 16 shows a zip code interface, according to an illustrative embodiment of the present invention.

FIG. 17 shows a calendar list interface, according to an illustrative embodiment of the present invention.

FIG. 18 shows a caveat interface, according to an illustrative embodiment of the present invention.

FIG. 19 shows a locate file interface, according to an illustrative embodiment of the present invention.

FIG. 20 shows a closing calendar interface, according to an illustrative embodiment of the present invention.

FIG. 21 shows a detailed calendar interface, according to an illustrative embodiment of the present invention.

FIGS. 22-25 show an order request form interface, according to an illustrative embodiment of the present invention.

FIG. 26 shows an error order interface, according to an illustrative embodiment of the present invention.

FIG. 27 shows a summary order interface, according to an illustrative embodiment of the present invention.

FIG. 28 shows a file management interface, according to an illustrative embodiment of the present invention.

FIG. 29 shows a search tool used to search the file management interface of FIG. 28, according to an illustrative embodiment of the present invention.

FIG. 30 shows a milestone manager interface, according to an illustrative embodiment of the present invention.

FIGS. 31 and 32 show a title search interface, according to an illustrative embodiment of the present invention.

FIG. 33 shows an update current status interface, according to an illustrative embodiment of the present invention.

### DETAILED DESCRIPTION OF THE INVENTIONS

The present invention now will be described more fully hereinafter with reference to the accompanying drawings, in which preferred embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

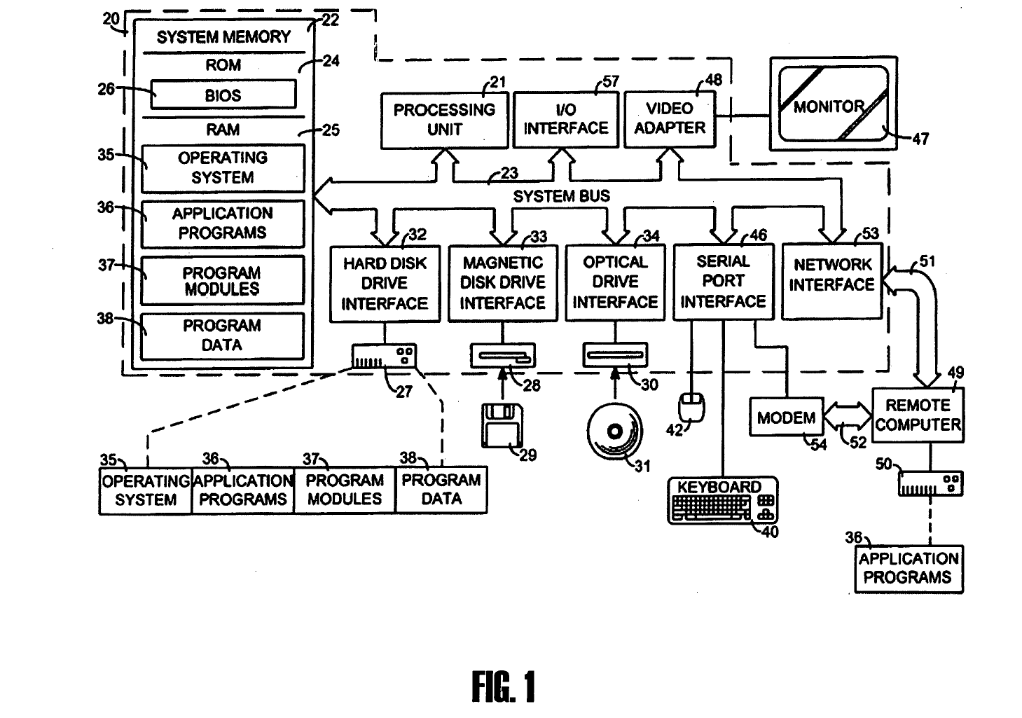

FIG. 1 and the following discussion are intended to provide a brief, general description of a suitable computing environment in which the invention may be implemented. Although not required, the invention will be described in the general context of computer-executable instructions, such as program modules, being executed by one or more computers. Generally, program modules include routines, programs, objects, components, data structures, etc. that perform particular tasks or implement particular abstract data types. Moreover, those skilled in the art will appreciate that the invention may be practiced with other computer system configurations, including a client-server system, multiprocessor systems, microprocessor-based or programmable consumer electronics, network PCs, minicomputers, mainframe computers, and the like. The invention may also be practiced in distributed computing environments where tasks are performed by diverse and/or remote processing devices that are linked through a communications network such as a local area network (LAN), wide area network (WAN), or the Internet.

With reference to FIG. 1, an exemplary system for implementing the invention includes a general purpose computing device in the form of a conventional computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routine that helps to transfer information between elements within the personal computer 20, such as during start-up, is stored in ROM 24.

The personal computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, CDs, DVDs, random access memories (RAMs), read only memories (ROMs), and the like, may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38. A user may enter commands and information into the personal computer 20 through input devices such as a keyboard 40 and pointing device 42 (such as a mouse). An I/O interface 57 is connected to the system bus 23, thereby allowing input data to be routed to and stored in the RAM 25, or one of the other data storage devices associated with the computer 20. The data can be input into the computer 20 from any of the aforementioned computer-readable media, as well as other input devices (not shown) which may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as a remote computer 49. The remote computer 49 may be a computer, a server, a router, a network PC, a peer device or other common network node, and typically includes many or all of the elements described above relative to the computer 20. The logical connections depicted in FIG. 1 include a local area network (LAN) 51 and a wide area network (WAN) 52. Such networking environments are commonplace in offices, enterprise-wide computer networks, Intranets and the Internet. When used in a LAN networking environment, the computer 20 is connected to the local network 51 through a network interface or adapter 53. When used in a WAN networking environment, the computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used. The computer 20 may be used as a server computer or client computer for implementing the invention described below.

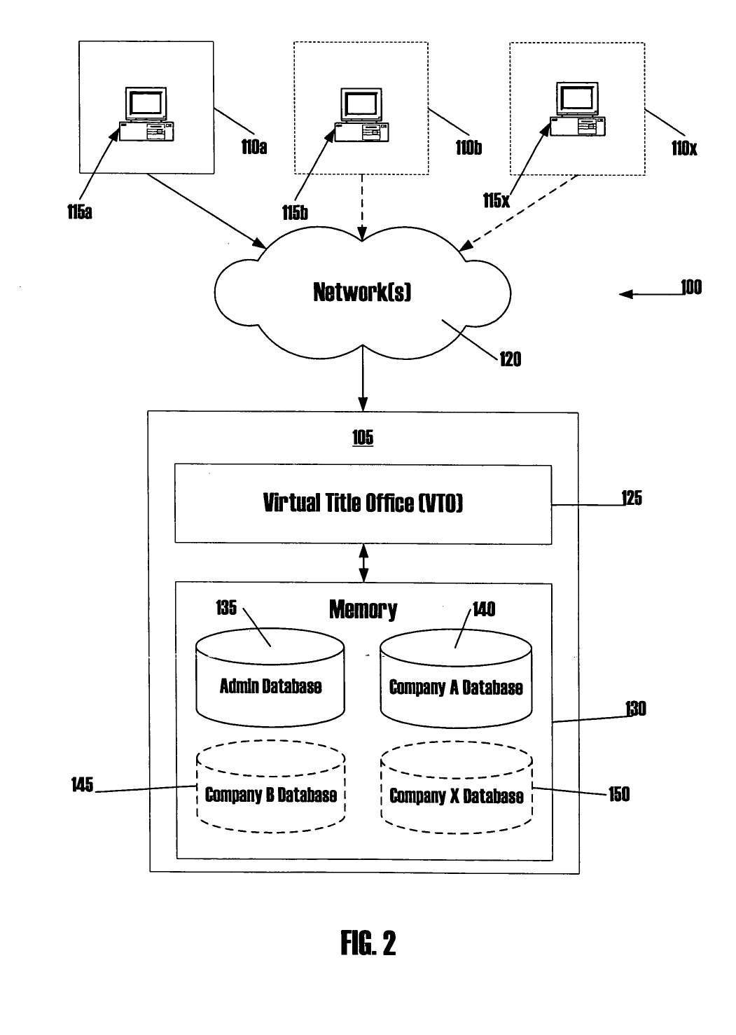

FIG. 2 shows a block diagram illustrating an exemplary system 100 in accordance with certain exemplary embodiments of the present invention. According to one embodiment of the present invention, the system 100 of the present invention is a system for managing one or more real-estate transactions, such as real-estate closings. The system 100 generally includes one or more computers 115a, 115b, . . . , 115x in remote or local communication with a server 105 via one or more networks 120. Each one of the computers 115a, 115b, . . . , 115x and/or server 105 may include features described above with respect to the computer 20 of FIG. 1.

One or more users operating the one or more computers 115a, 115b, . . . , 115x access the Virtual Title Office (VTO) 125, which may be one or more software modules or applications executed by the server 105 with the aid of a processor and operating system (not illustrated), as is well known in the art. As used herein, any data related to a real-estate transaction, along with any documents relating to a real-estate transaction, is generally referred to as transaction information. Transaction information includes pre-closing, closing and post-closing documents, information related to clients of the company (e.g., names, addresses, etc.), real-estate agent information and lists, title company information and lists, title documents, surveys, caveat lists, calendars and schedules, and like information that permits all parties associated with a loan closing to access pertinent information to permit them to obtain all of the knowledge they require to perform their respective jobs.

According to a preferred embodiment of the present invention, the server 105 comprises an internet server accessible by one or more users via the one or more networks 120, which may comprise, e.g., a Local Area Network (LAN), a Wide Area Network (WAN), and/or the Internet. As illustrated in FIG. 2, user may access the server 105 and VTO 125 via a computer 115a located at a remote first location 110a, such as at the user's place of employment. For instance, where the user is an employee of a title search company, the user-employee may access the server 105 and VTO 125 from an Internet-connected computer located at the title search company. Although the first location 11a is illustrated as including a single computer 115a, it will be appreciated that multiple users may access the server 105 and VTO 125 via a plurality of computers (not illustrated) at the first location 11a, such as a plurality of computers on a LAN. As is also illustrated in FIG. 2, multiple users located at separate locations 110a, 110b, 110x may access the server 105 and VTO 125 via the network(s) 120. Such access from multiple users may occur simultaneously.

According to one aspect of the present invention, users accessing the VTO 125 may include attorney administrators, attorney employees, mortgage administrators, mortgage loan officers, and mortgage processors, buyers, sellers, and other individuals associated with the loan process. The VTO 125 permits such users to a real-estate loan transaction to access, view, upload and/or download transaction information related to a real-estate transaction such as a real-estate closing. In addition to storing transaction information, the VTO 125 generally provides users with user friendly GUIs for viewing and locating loans, loan status and for displaying information relevant to a real-estate loan transaction.

According to one aspect of the present invention, the VTO 125 may also communicate with third party databases to perform fraud checks or to confirm the accuracy of transaction information. For example, the VTO 125 may provide one or more check lists and caveat checks to eliminate the potential for fraud and the improper processing of a loan (e.g., where additional information is required before closing.) Because all information related to the loan is accessible via a network connection, such as via the Internet, each party to the loan has updated information regarding the status of the loan as well as access to transaction information, thereby significantly decreasing the time and expense required to process a transaction. The VTO 125 also enables users to manage transaction using one or more pages showing the current status of all transactions, using, in part, user-selected icons that may be selected to initiate an automated action, such as the ordering of a title report. As described in detail below, the VTO 125 is also operable to provide one or more check lists and caveat checks to eliminate the potential for fraud and the improper processing of a transaction.

As illustrated in FIG. 2, the VTO 125 is in communication with a memory 130 including an administrative database 135 and one or more company databases 140, 145, . . . , 150 that contain data viewed, posted, and/or accessed by users of the system 100. The administrative database 135 stores VTO administration information for administering the VTO 125, including user access rights (or site permissions) for various persons using the VTO 125, graphical user interfaces, graphics, logos, and the like. Each of the company databases 140, 145, 150 contains transaction information pertaining to transactions in which the respective companies are involved. According to one illustrative embodiment of the present invention, these companies may be real-estate law offices that manage real-estate loan processes. Therefore, brokers, lenders, title agencies, sellers, buyers, and other persons associated with a transaction may access transaction information stored within a company database associated with the real-estate law office that will act as closing attorneys on a transaction. Nevertheless, according to an alternative embodiment of the present invention, entities such as brokers and title search companies may also have local or remote databases for storing transaction information, even if the transaction information stored within their databases is duplicative, in whole or part, of the transaction information stored in one or more company databases. According to one aspect of the invention, the administrative database 135 and company databases 140, 145, 150 may be arranged in one or more logical data structures such as SQL databases and the like, as are known in the art.

According to one embodiment of the invention, numerous companies and/or entities (hereinafter referred to as “clients”) may establish their own company database to manage one or more real-estate transactions. The creation of a database may be facilitated by a VTO 125 administrator or automatically online through the use of one or more web pages that request information from a client to create individual or business accounts. For instance, a real-estate attorney may manage multiple transactions using the system 100, where the loan-related information for each of the attorneys' multiple transactions may be collectively stored in a single database established for that real-estate attorney. Loan-related information associated with individual transactions within the database may be stored within individual folders or as individual records within the database.

The set up of a company database may be automated by the VTO 125. This may be advantageous where the VTO 125 is internet accessible and a client such as a real-estate office decides to utilize the features of the invention to assist in their real-estate closings. Therefore, to set up a database the VTO 125 may query the client for identification and payment information, where the identification information is used to automatically establish a database for storing transaction information associated with the attorney's real-estate transactions. This automated process may also be used to establish individual records within a company database for each real-estate transaction. It will be appreciated that automating the process requires that one or more GUIs be provided to a user to set up a new real-estate transaction. It will also be appreciated that the database for each company may be set up by a system administrator rather than automatically.

Although for purposes of brevity the present invention will be described as including one database for each company, where each transaction within the database is segregated, it will be appreciated that the VTO 125 of the present invention may also be implemented using different database configurations. For instance, according to one aspect of the invention, transaction information for each loan transaction may be stored in its own database. Alternatively, a single database may be used to store all transaction information for all transactions and for all companies or users accessing the VTO 125. Where one database is used, each piece of loan-related information may be associated with a user, company, and/or transaction such that the VTO 125 can readily identify loan-related information pertaining to a particular transaction. For instance, all data corresponding to a loan may have a unique transaction number associated with it. Regardless of the number of databases utilized, or the manner in which content such as loan-related information is stored, the identification of a user attempting to access information may be used by VTO 125 to verify whether the user has rights to access requested transaction information.

According to one aspect of the system, each of the numerous companies and entities (hereinafter referred to as “clients”) which use the system 100 of the present invention may customize the system 100 in addition to setting up accounts and databases for the storage of information. For instance, a law office that performs real-estate closings that uses the system 100 for all of its real-estate closing may customize the system. This includes customization of the graphical user interfaces, graphics, logos, fonts, features, and the like so that each client may be presented with GUIs that match a particular look and feel desired by the client and generally appear customized for the particular entity rather than shared among multiple entities. Additionally, as explained in detail below, each client may also establish their own site permissions, such as what features of the VTO 125 each user may access or use. To effect these features, the company databases 140, 145, 150 may also include separate company administrative information stored in each respective company database. The company administrative information is preferably separate from VTO administration information stored in the administrative database 135 for administering the VTO 125, although this is not required. It will also be appreciated that company administrative information is different from transaction information, which includes the data that is posted and/or accessed and viewed by the individual users.

It will be appreciated that the methods of the present invention described above and with respect to the GUIs described below may be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the description herein and illustrated in the GUIs generated by the VTO 125. Such computer program instructions may also be stored in a computer-readable memory that can direct a computer or other programmable data processing apparatus to function in a particular manner, such that the instructions stored in the computer-readable memory produce an article of manufacture including instruction means that implement the functions specified herein. Therefore, the methods described herein may be implemented by a modeling tool comprising a processor, operating system, memory, input/output interface, one or more databases and a bus.

Further, the methods described herein may be embodied as a data processing system or a computer program product on a computer-readable storage medium having computer-readable program code means embodied in the storage medium. Any suitable computer-readable storage medium may be utilized including hard disks, CD-ROMs, DVDs, optical storage devices, or magnetic storage devices. Accordingly, the present invention may take the form of an entirely hardware embodiment, an entirely software embodiment or an embodiment combining software and hardware aspects, such as firmware. According to a preferred embodiment, the methods described herein are implemented by a stand-alone software application operating on a Windows® operating system. However, the methods may be implemented using alternative operating systems and databases as are known to those of skill in the art.

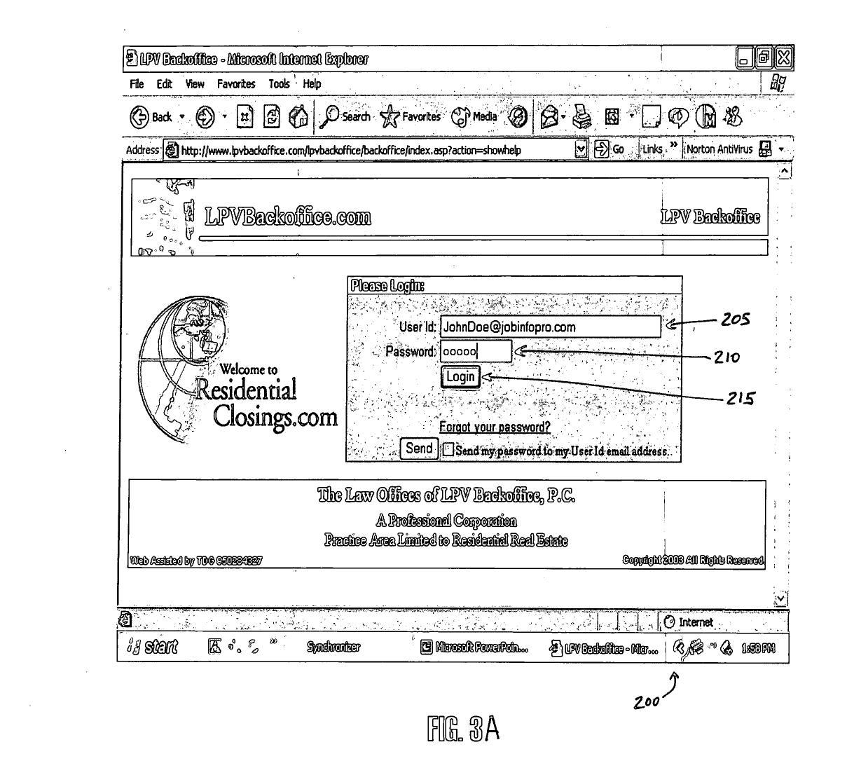

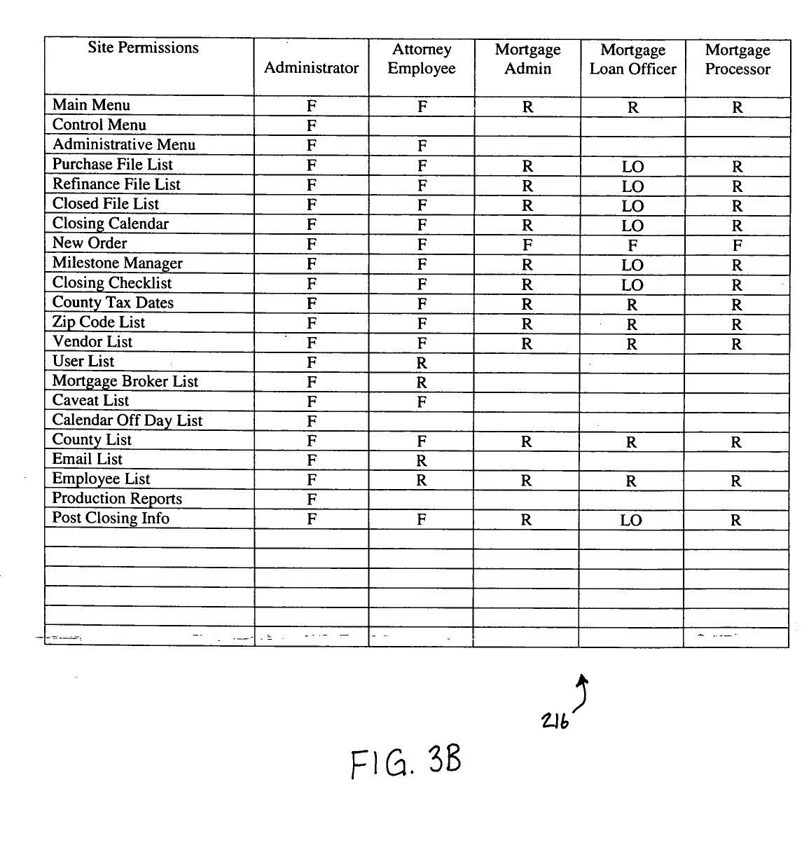

As described above, using the VTO 125, new real-estate transactions may be entered into the system by a client. To access the features of the VTO 125, a user associated with a client and transaction must initially log into the VTO via a log interface 200 for security purposes. As shown in the log interface 200 of FIG. 3, a user may have to enter a valid user id 205 and password 210, and select a login button 215 to access the features of the VTO of the present invention. According to one aspect of the present invention, the ability to access to features within the VTO 125 are dependent upon the user id and password. The administrative database 135 may contain a list of all user ids and passwords having access the VTO 125, where each user id and password is associated with particular transactions.

Furthermore, users may have respective rights to use features provided by the VTO 125 within each transaction, which may including rights to edit, access, post, delete and/or view VTO administrative information, company administrative information, and/or alter transaction information. For instance, a VTO site administrator, real-estate attorneys or their employees, mortgage administrators, mortgage loan officers, and mortgage processors may have differing rights associated with their respective identifications. According to one aspect of the invention, these respective rights may be stored in a table within the administrative database 135 identifying a user as a member of a particular class of users having particular rights associated therewith. An illustrative example of such a table is provided in FIG. 3B, which is an illustrative and informal site permission table 216 identifying users generally as having full access (“F’), read only access (“R”), or the ability to view only Loan Officers files (“LO”) in the respective GUIs provided by the VTO 125, which are discussed in detail below. For instance, a VTO site administrator may have a user id and password giving the administrator full rights to access, post and delete all transaction information and administrative information. According to another illustrative embodiment of the present invention, in a real-estate closing transaction, a mortgage processor may only have read-only access to particular transaction related information because the mortgage processor has no reason to download or post transaction information in such a transaction.

After a user has completed the log-in process, the VTO 125 will only permit the user to access, view, delete and/or download information the user has rights to access, view, delete and/or download. According to one aspect of the invention, the VTO 125 will not provide the user with GUIs having links that allow the user to access content the user's id and password do not provide rights to access. According to an alternative embodiment of the present invention, the GUIs provided to each user will remain the same, but the links and/or control of such features and functions will not work where the user has no rights to the features and functions.

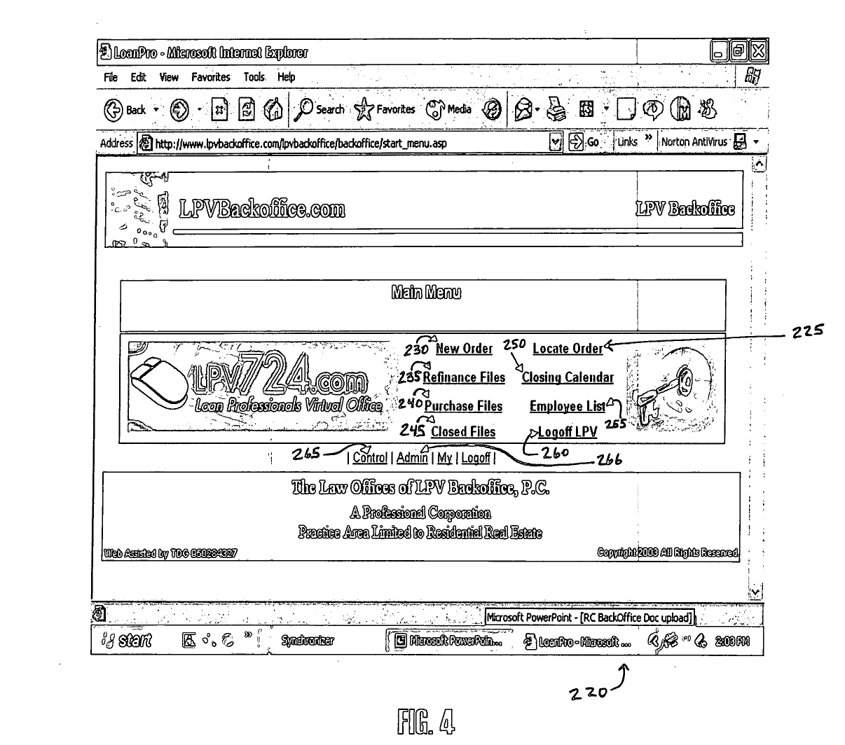

After login is complete, the user may be provided with a menu, such as the main menu interface 220 illustrated in FIG. 4. This illustrative menu presents options to users associated with a real-estate loan or closing transaction. Although the features of the present invention may be used to manage multiple types of transactions, for brevity and clarity the remaining illustrative GUIs generated by the VTO 125 will be described with reference to real-estate closing transactions managed by a client law firm having multiple employees.

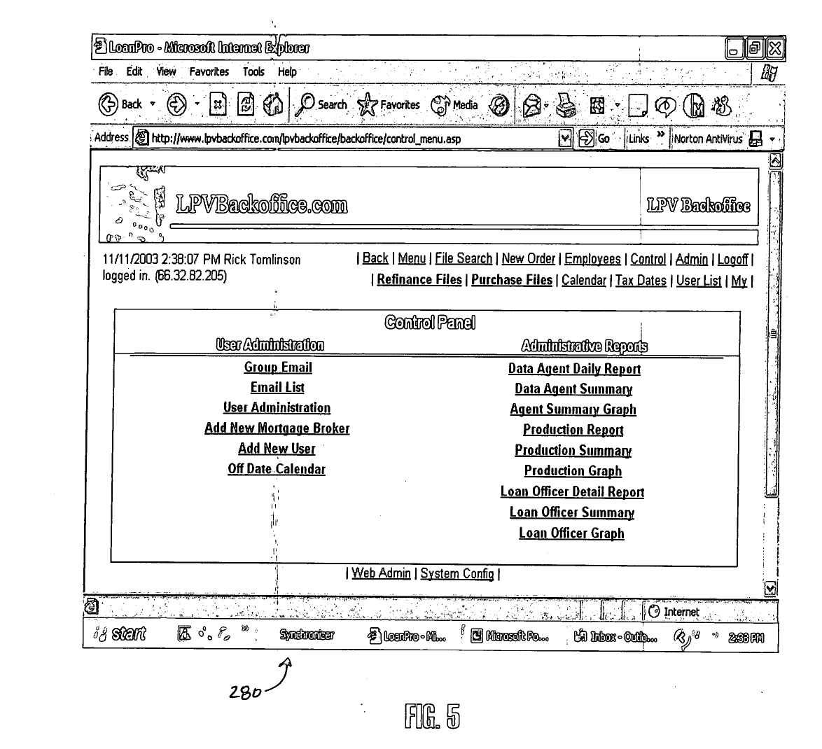

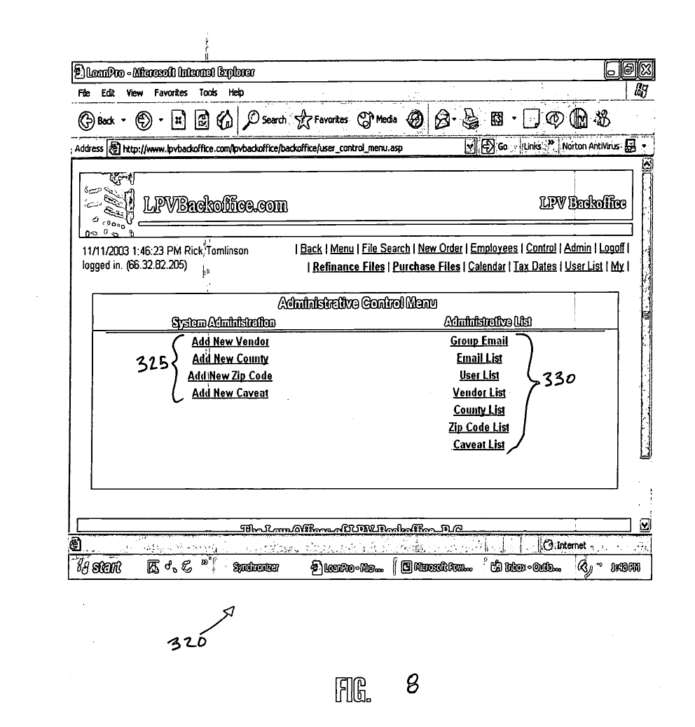

As shown in FIG. 4, the menu interface 220 permits a user to select one or more links to locate a transaction (i.e., ‘locate order’) by its unique file number (link 225), to request a new order (i.e., ‘new order’) (link 230), to access refinance transactions (i.e., ‘refinance files’)(link 235), to open purchase files (i.e., ‘purchase files’)(link 240), to view a list of closed files (i.e., closed transactions, or ‘closed files’)(link 245), to view a real-estate closing calendar (i.e., ‘closing calendar’)(link 250), to view a list of employee names and contact information (i.e., ‘employee list’)(link 255), and to log out of the VTO (i.e., ‘logoff LPV’)(link 260). The main purpose of these links is to allow a user to identify a transaction the user would like to access, or to view other basic information related to transactions. The main menu interface 220 also includes a control link 265 to allow users to access a control panel interface, described below with respect to FIG. 5, and an admin link 266 to permit access to an administrative control interface, described below with respect to FIG. 8. Features accessible via the control link 265 and admin link 266 will next be discussed, followed by a discussion of the remaining links 225, 230, 235, 240, 245, 250, 255 to manage a particular transaction.

FIG. 5 shows a control panel interface 280 that is accessed by a user by clicking on the control link 265 provided in the main menu interface 220 of FIG. 4. According to one aspect of the invention, the control panel interface 280 is only accessible by a user having administrative rights to access and edit this information. Generally, the control panel interface 280 allows a user to send a group email (i.e., ‘group email’), view email addresses (i.e., ‘email list’), add new users (i.e. ‘add new user’) or mortgage brokers (i.e., ‘add new mortgage broker’), and manage rights of users (i.e., ‘user administration’). The control panel interface 280 also allows a user to run reports and to produce graphs, as discussed below. Generally, the control panel interface 280 may be used to generate new users and to manage their respective access rights. This may include establishing user ids and passwords. It will be appreciated that changes to users facilitated by the control panel interface 280, such as the addition of a new user or a change in a user's rights to view, access, post, and/or delete transaction information, will result in the VTO making changes to the admin database and/or company database that the VTO accesses to manage users and their respective rights.

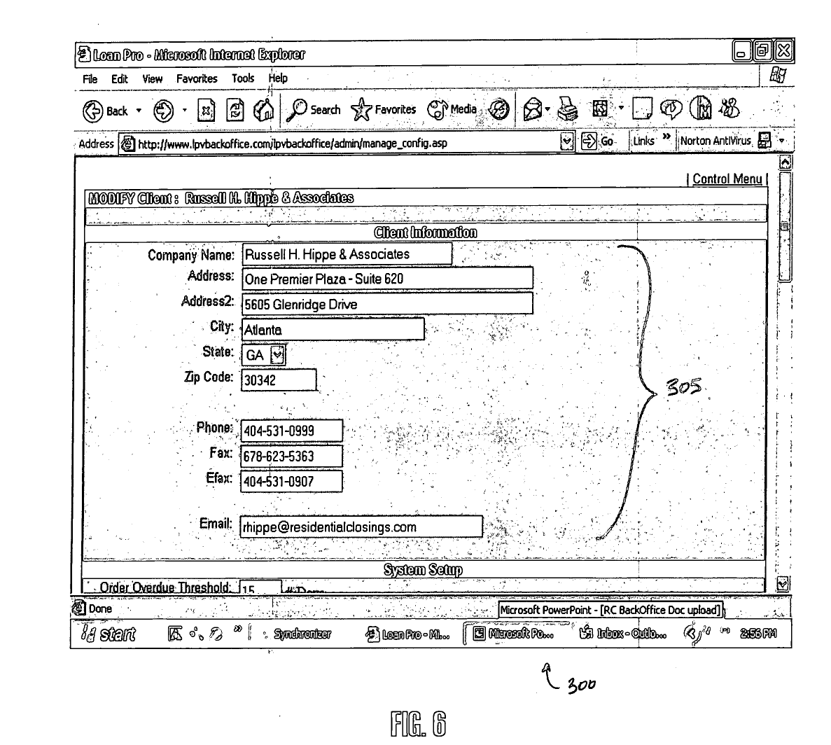

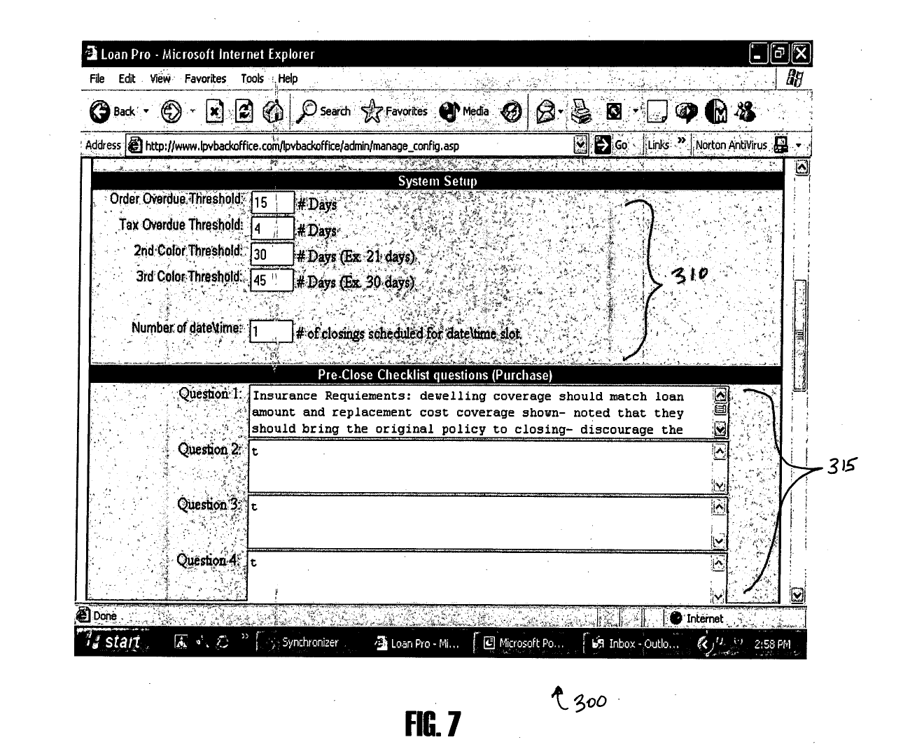

FIGS. 6 and 7 show a client modify interface 300 for modifying a client that may utilize the VTO. According to one aspect of the invention, this interface 300 may be accessed via a web admin or like link on the control panel interface 280 of FIG. 5. The client modify interface 300 allows the input of client information 305 such as a company name, address and relevant telephone contact numbers. This interface helps to ensure that all transactions have the correct contact information available. This may be important, for instance, where the VTO 125 may automatically generate emails or facsimiles to entities associated with a transaction. The interface 300 also allows the setup of transaction thresholds 310 and pre-closing checklist questions 315 associated with the client. This enables a particular client, such as a client law firm, to configure its transaction information, for instance, for all real estate transactions it manages using the VTO 125. As noted above, this information is stored as transaction information in the company database associated with the client.

Next, FIG. 8 shows an administrative control interface 320 that is accessed by a user by selecting the admin link 266 provided in the main menu interface of FIG. 4. According to one aspect of the invention, like the control panel interface 280 features, only a user having administrative rights may access the options provided from this interface 320 in order to maintain accurate information on clients, users, commercial entities and other pertinent information associated with transactions, such as tax information and caveat lists, as described in detail below. As shown in FIG. 8, one or more links 325 in the interface 320 permit the addition of and revision of entities, and lists thereof, that may be associated with a client transaction, such as a mortgage title company vendor, loan officers, processors, banks and insurance agents.

Links 325 also permit an administrator to ‘add new county’, ‘add new zip code’, which allow a user to input due dates for city and county taxes related to a real-estate loan. Additionally, by selecting ‘add new caveat’, a caveat list of fraud names and addresses may also be viewed and updated. As described in further detail below, before a loan is completed, the terms of the loan may be checked against one or more caveat lists to decrease the likelihood of fraud. Currently, such processes are performed manually and may be overlooked in the loan process. The features provided by each of these links are considered below. The interface 320 also provides links 330 that allow a client to transmit a group email to employees of entities associated with a transaction, and to view a list of vendors, employees, and the like.

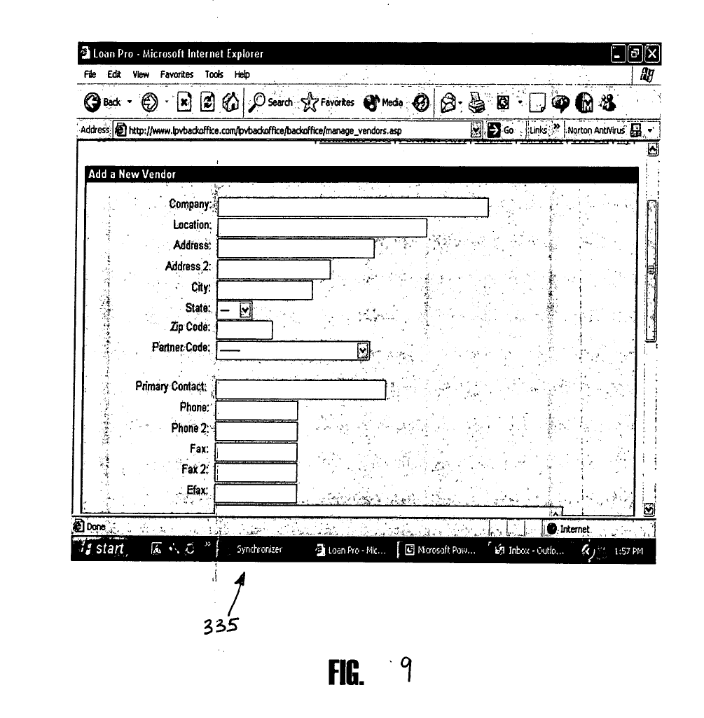

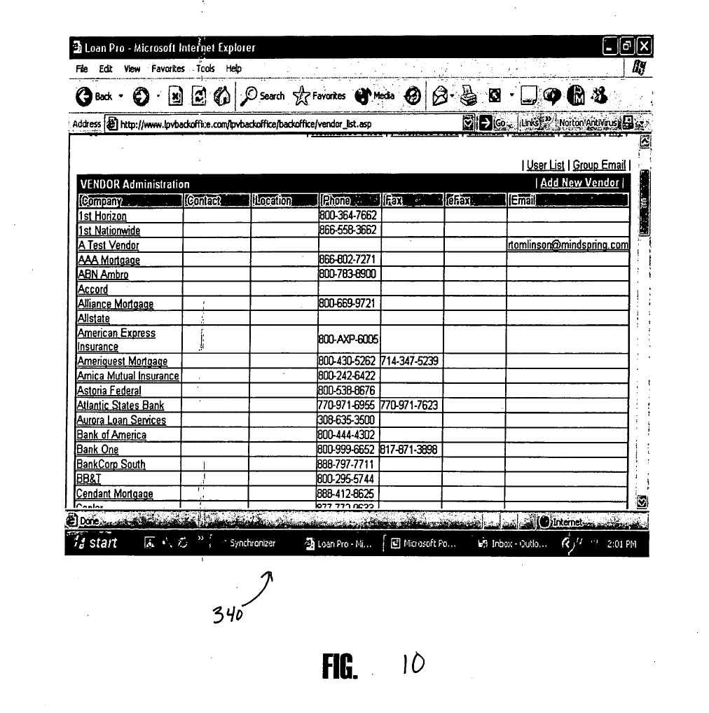

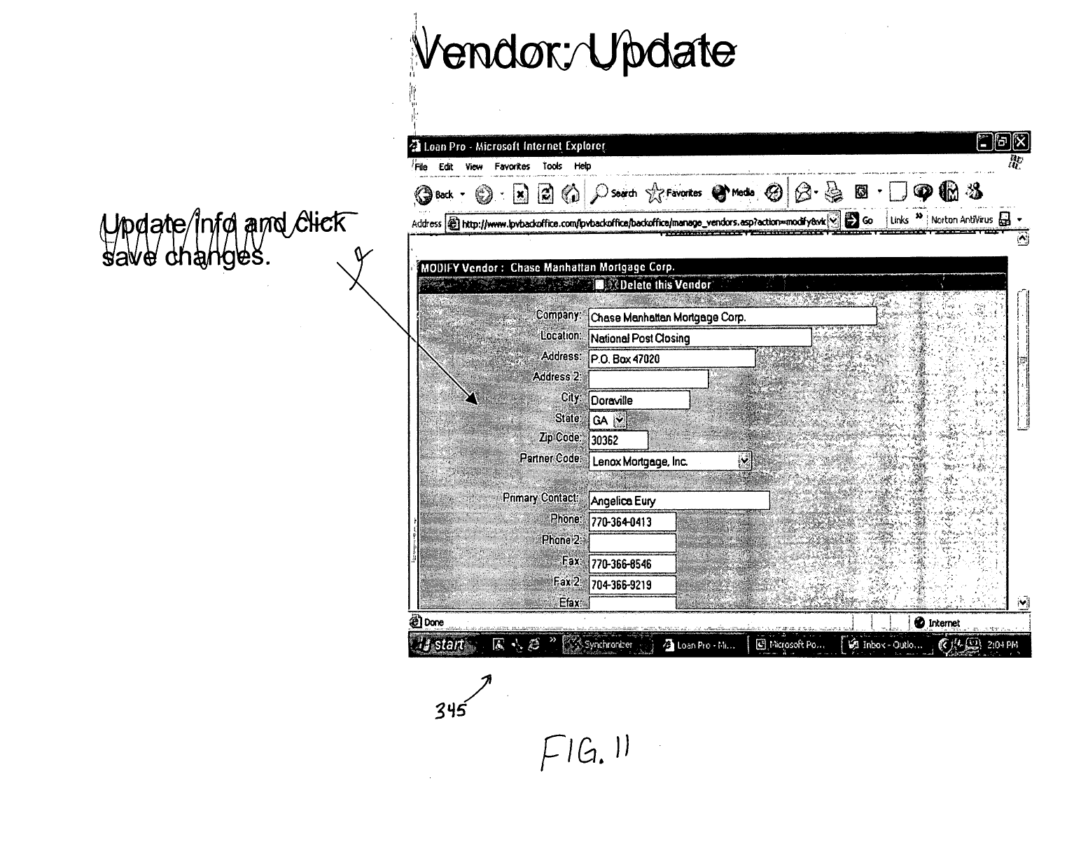

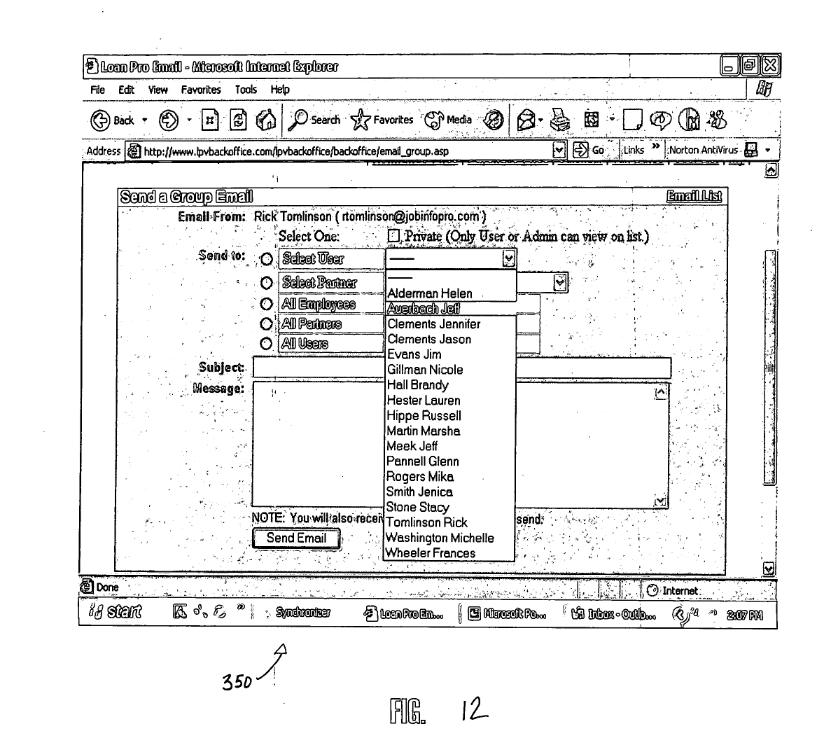

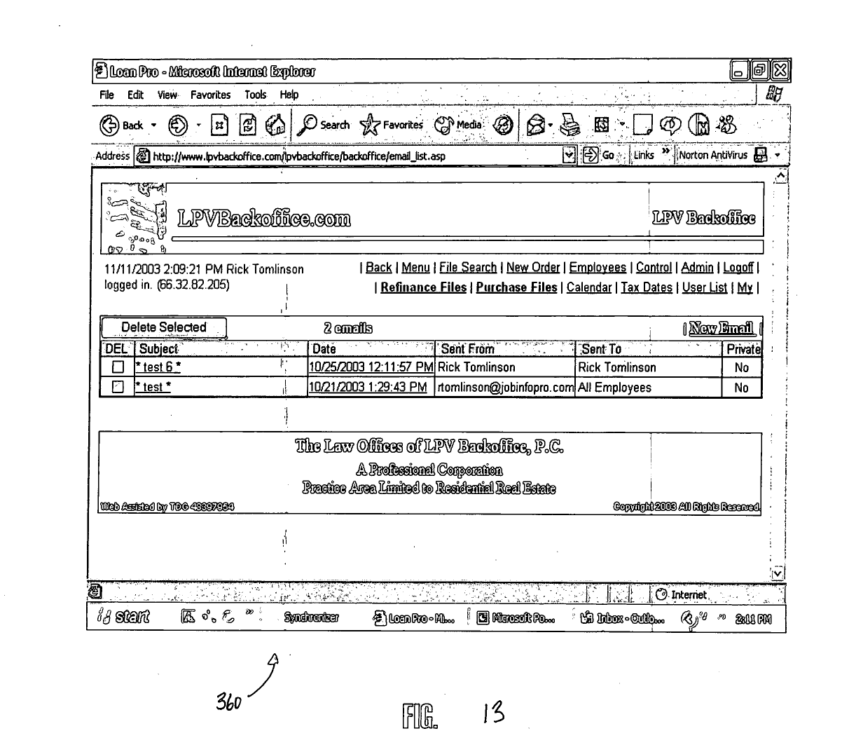

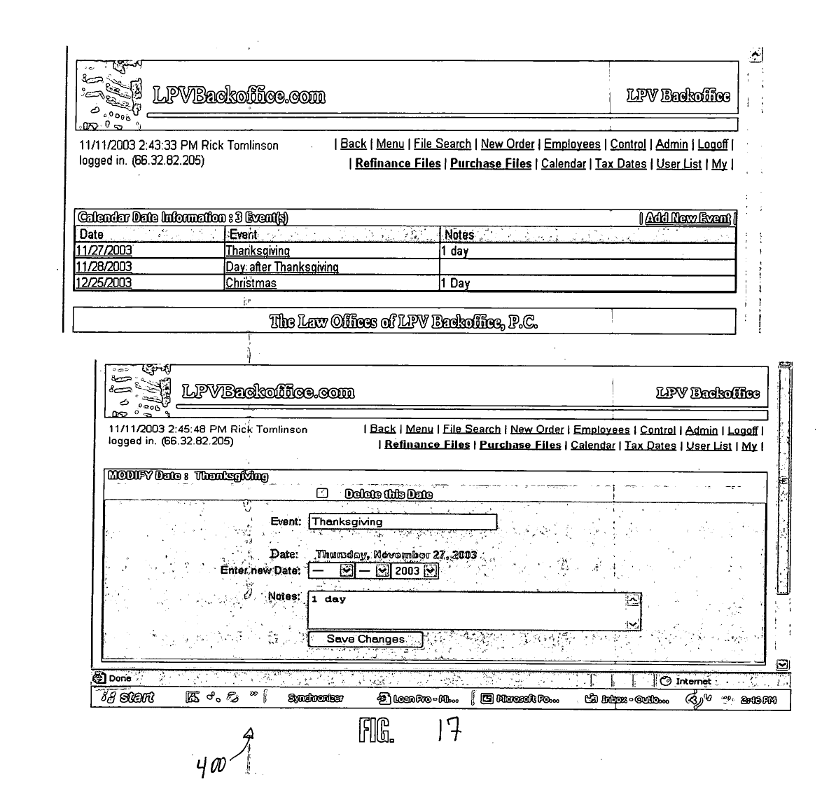

Next, FIG. 9 shows a new vendor interface 335 for inputting information corresponding to a company or commercial entity that may be associated with a transaction. This interface may be accessed via the administrative control interface 320 and permits identification and contact information for commercial parties to a transaction, such as loan officers, borrowers, title searchers, and other parties affiliated with the loan, to be collected and saved. FIGS. 10 and 11 also illustrate a vendor list interface 340 and a vendor update interface 345, respectively, that permit a user to quickly access and update contact information for parties to a transaction. The group email interface 350 shown in FIG. 12 is also accessible via the administrative control interface 320 and permits a user to select one or more email recipients, including recipients selected from a pull down list of recipients stored by the system. According to one aspect of the invention, these recipients may be employees of a client or parties to a transaction whose email addresses are maintained by the VTO 125. Using conventional email features, the VTO 125 enables a user to easily identify and transmit an email to a group of recipients. According to one aspect of the invention, an email list interface 360 shown in FIG. 13 may also be accessed from the administrative control interface 320, which shows a list of emails transmitted to one or more recipients. The integration of this email capability allows the VTO 125 to operate as a standalone application for managing all functions related to a transaction, such that a stand-alone computer remotely accessing the VTO 125 does not need any software other than browser software. Additionally, a calendar interface 400 like the one shown in FIG. 17 may also be provided to display all upcoming dates, such as closing dates, associated with one or more transactions handled by the client. According to one aspect of the invention, using the calendar entries may be made and appointments may be moved.

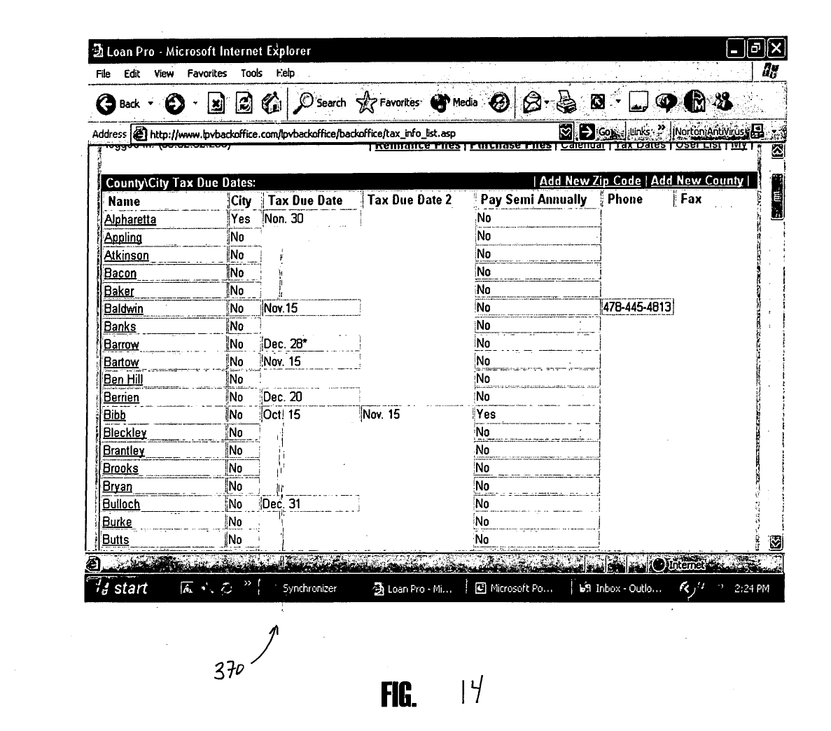

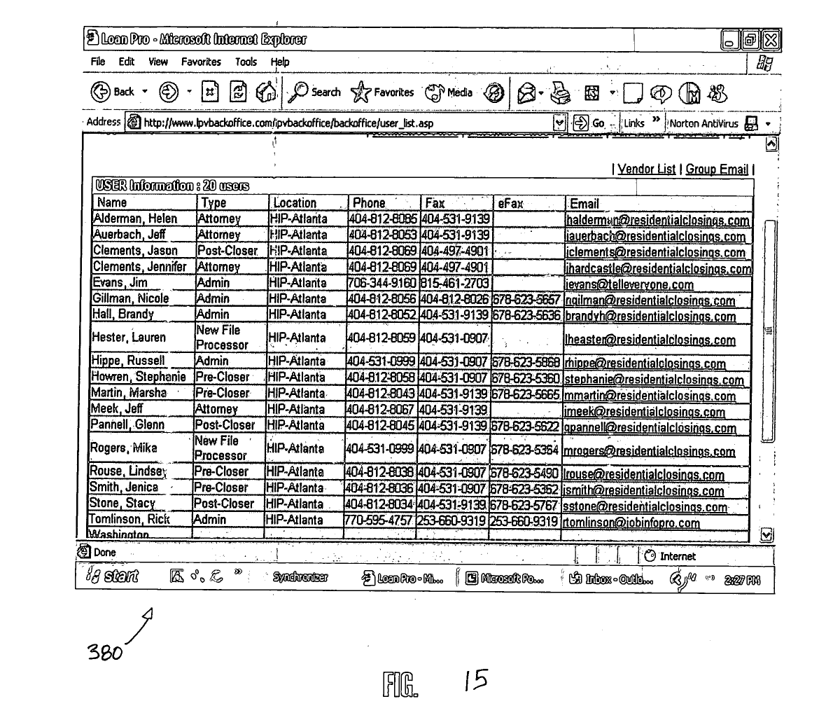

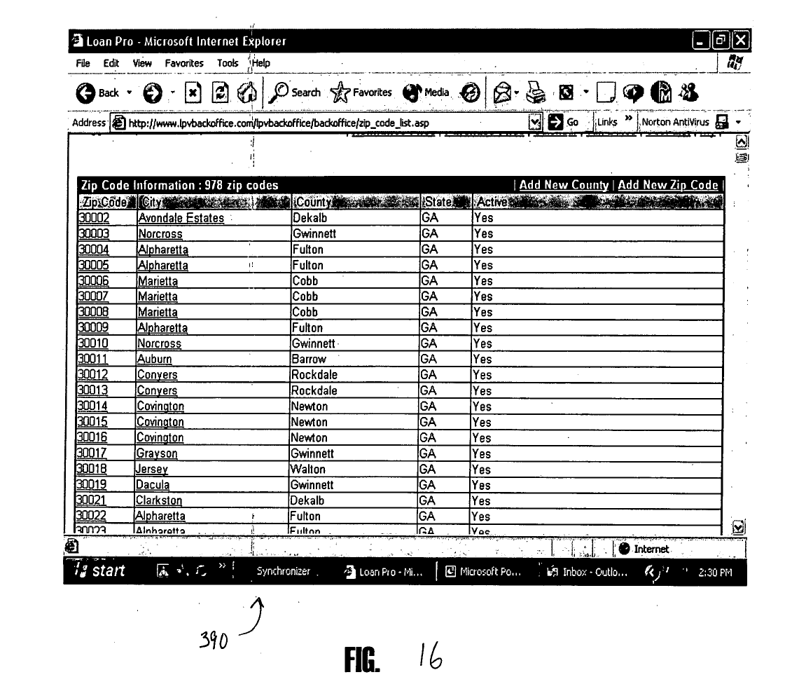

Also accessible via the administrative control interface 320 is a county list interface 370, as shown in FIG. 14. This list may be revised to maintain a current record of due dates for city and county taxes related to real-estate loans. A revisable zip code list for may also be accessed via a zip code interface 390, as is shown in FIG. 16, where counties and cities associated with each zip code are listed. A user list 380 may similarly be revised and updated by a user selecting the user list link from the administrative control interface 320, such as the illustrative user information interface 380 shown in FIG. 15. Other interfaces are accessible via the administrative control interface 320, such as interfaces permitting the updating of vendors and commercial entities that may be parties to one or more transactions. In general, using the administrative control interface 320 a site administrator may add new or update information on users, loan officers, processors, banks and insurance agents, and the like.

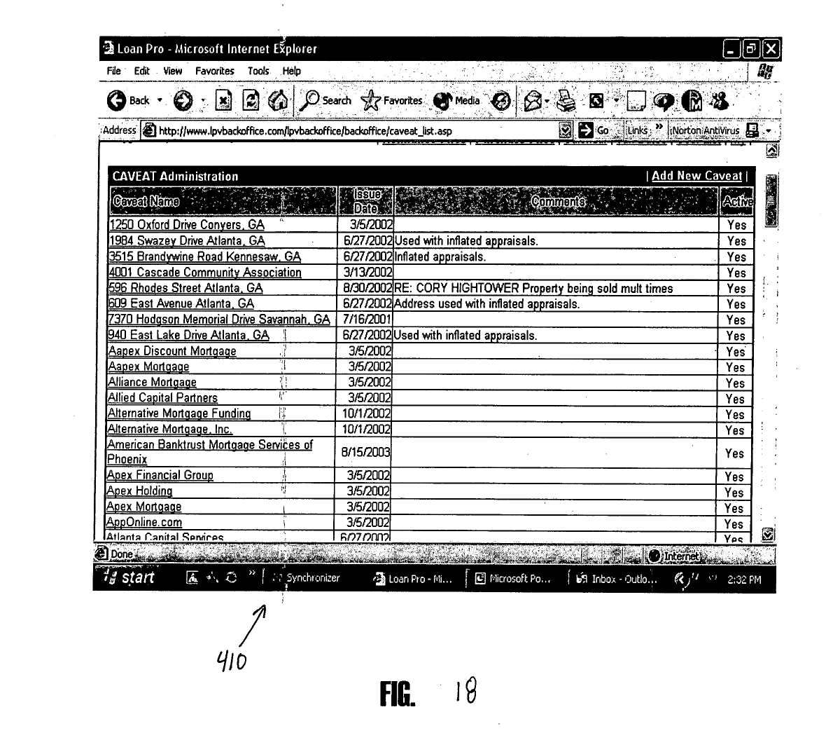

Next, the administrative control interface 320 may also be used to access and revise a caveat list. The caveat list may include a list of fraudulent names, addresses company names, and the like, along with comments for each, to identify potentially fraudulent information that may be provided by a party to a loan. Therefore, some or all transaction information may be compared against the information stored in the caveat list to identify potentially fraudulent activity or information. According to one embodiment of the present invention the caveat list is maintained local to the VTO 125. However, according to an alternative embodiment of the present invention the caveat list may also be stored in a database external to the VTO 125 and server 105, such as a third party database accessible via a LAN, WAN or the Internet. Therefore, lenders, title companies, or the like, may maintain one or more caveat lists that are reviewed by the VTO. The caveat list is presented in the caveat interface 410 shown in FIG. 18, which may be accessed by a user via selection of the ‘caveat list’ link in the administrative control interface 320.

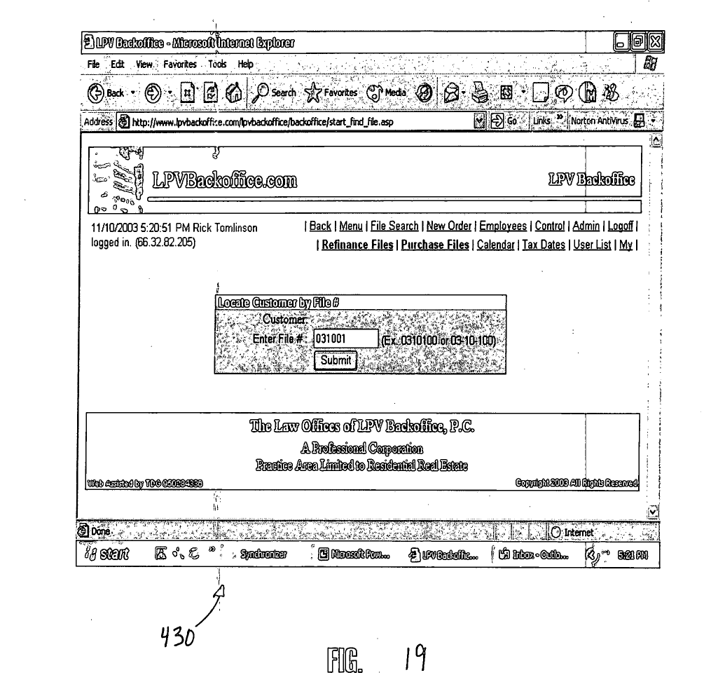

Referring once again to the main menu interface 220 described above with respect to FIG. 4, a user may select a transaction via its unique file number by clicking on the ‘locate order’ link 225. According to one aspect of the invention, when this occurs a locate file interface may be provided to the user, such as the illustrative locate file interface 430 shown in FIG. 19. The user can access a file by entering the file number and pressing the submit button. As noted above, upon entry of the file number the user's id and password will be compared against the file to determine the user's right to access, download, post and/or delete transaction information associated with the file. Upon entering a valid file number, a client can view the status of the file and update any necessary information associated with the file. The loan officer may also click on a link to check on the progress of one of the five milestones, which include Title Search, Tax Search, Subordination, Mortgage Payoff and Hazard Insurance. These milestones are discussed in detail below. The user may also download documents (e.g., tax documents) using a document manager and/or print documents or check lists for a transaction.

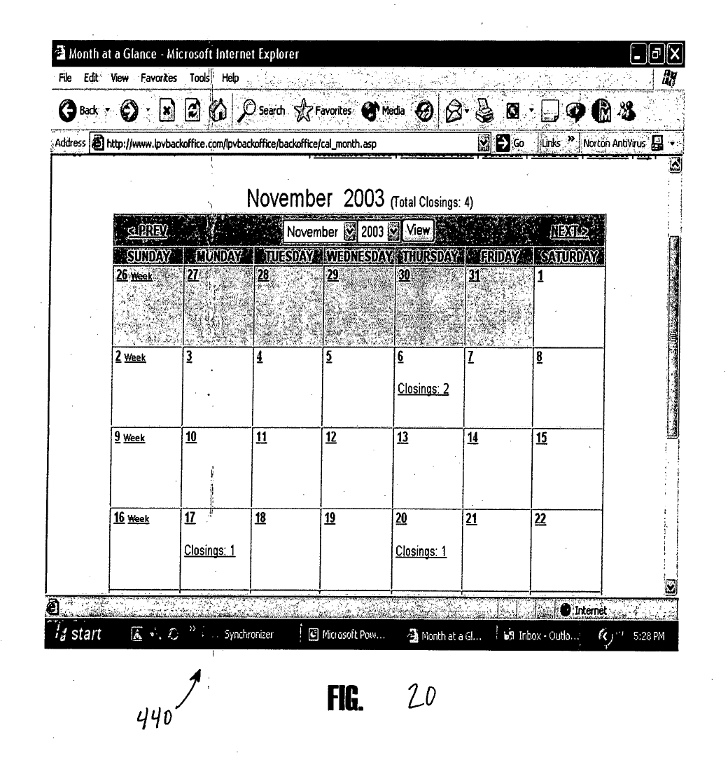

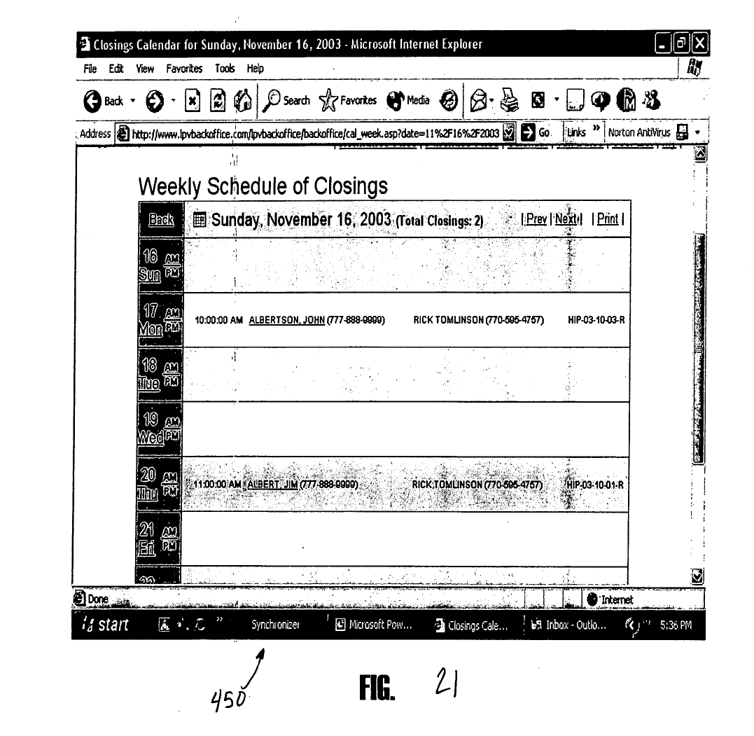

Next, a closing calendar interface 440 shown in FIG. 20 may also be accessed from the main menu interface described above with respect to FIG. 4 where a user selects the ‘closing calendar’ link 250. This calendar shows monthly activities related to transactions, such as closing dates. Additionally, by clicking on a week within the calendar, a detailed calendar interface may be presented to a user, such as the illustrative detailed calendar interface 450 shown in FIG. 21. It should be appreciated that both calendar interfaces enable the modification of a calendar by users having sufficient authority to do so.

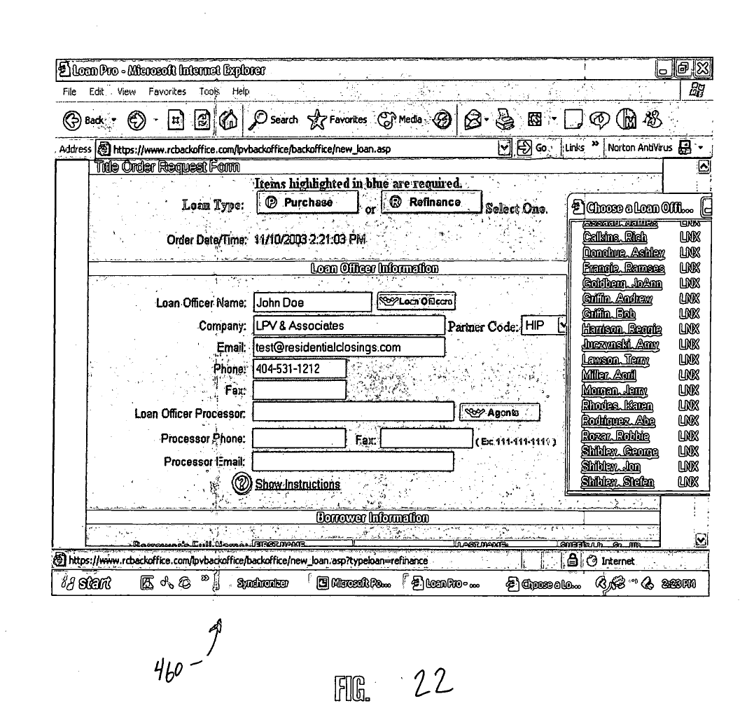

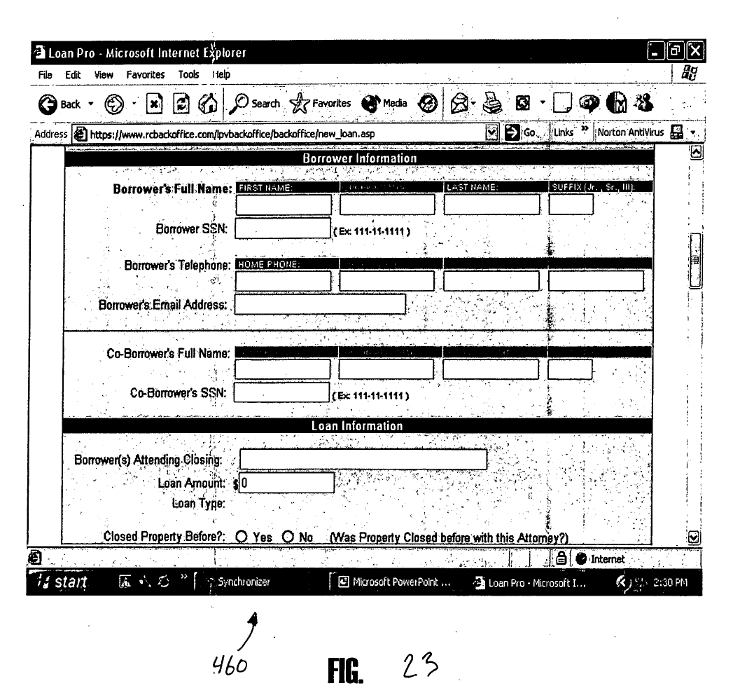

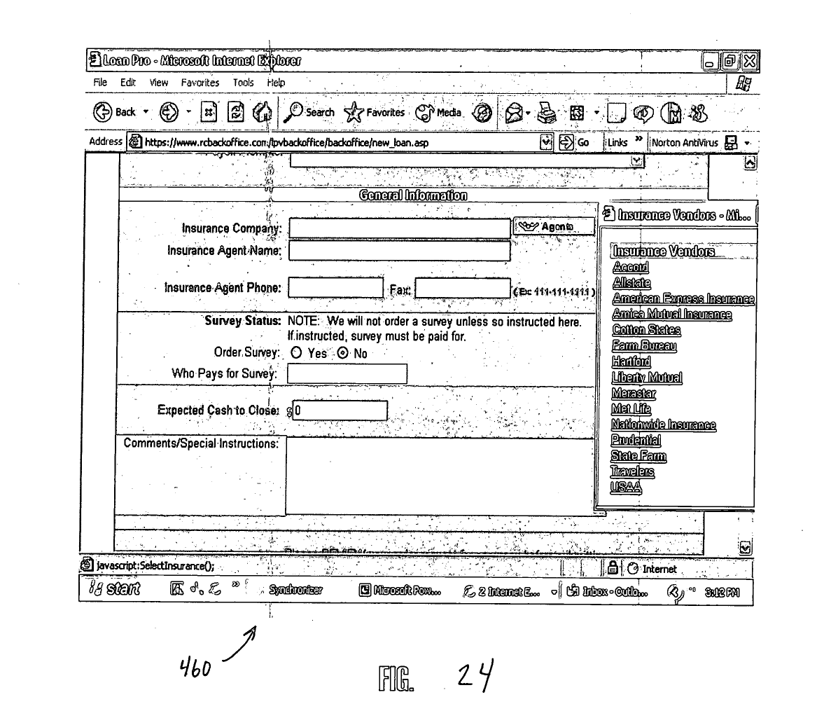

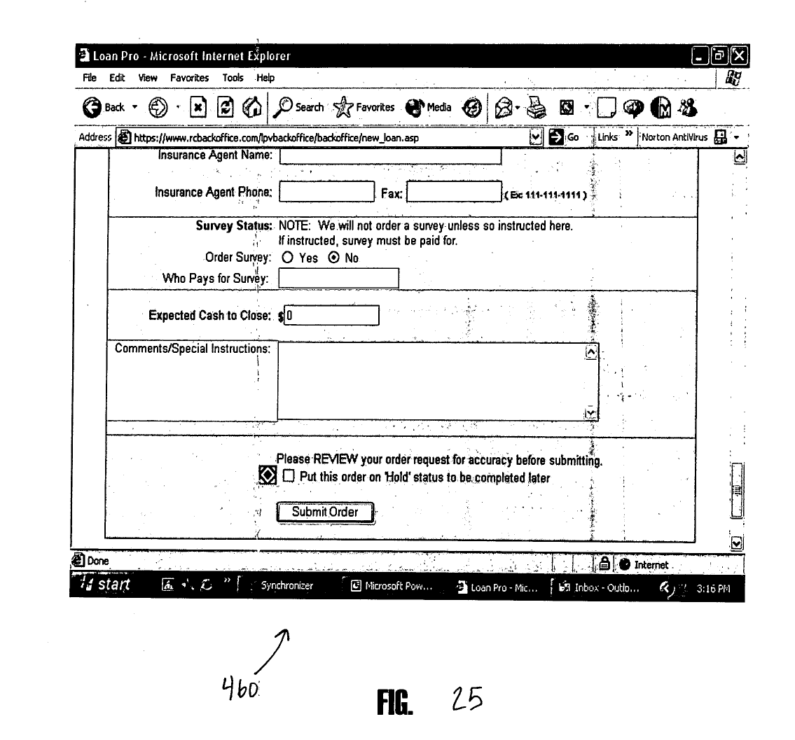

From the main menu interface 220 a user may also choose to request a new order by selecting the ‘new order’ link 230. When this occurs, the user is presented with a order request form interface, such as the illustrative order request form interface 460 shown in FIGS. 22-25. Using this interface 460 the user may identify a loan type as purchase or refinance, and may select a loan officer (here, an attorney-employee of the client) from a pop-up list. As described above, these persons are identified by a configurable employee list. According to one aspect of the invention, an agent or loan office processor may also be selected from a pull-down or pop-up list. As with the employee list, the names and contact information for these persons are stored within the company database after having been input into the VTO 125 by a user. The order request form interface 460 also allows a user to input borrower and loan information, including the borrower's identification information, the loan amount, the loan type, the borrower's current address, and property information such as the address, lot number and the like. Lender information may also be input either manually or using a pop-up or pull down list provided by the lenders previously input into the VTO. Additional information such as insurance companies and comments concerning the loan may also be input, as illustrated in FIGS. 24 and 25.

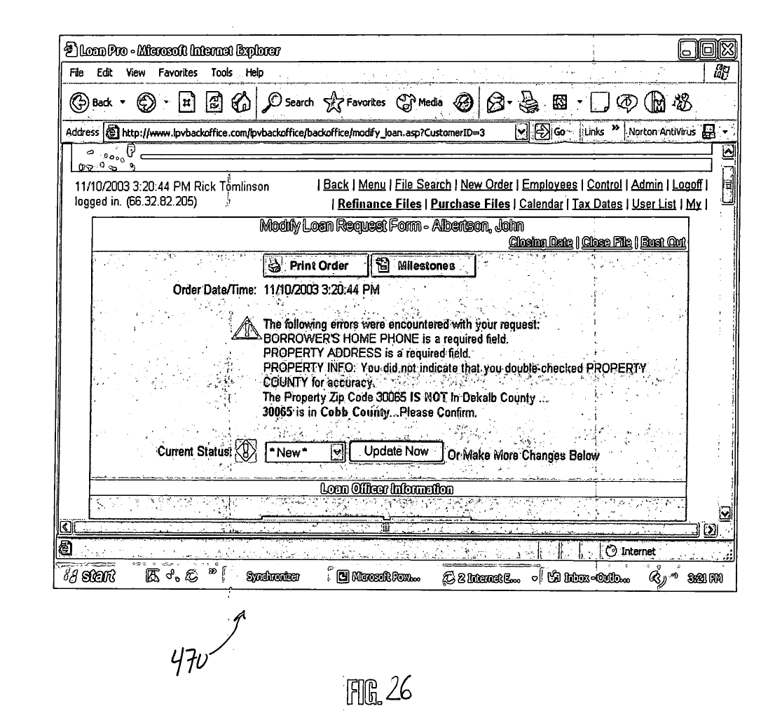

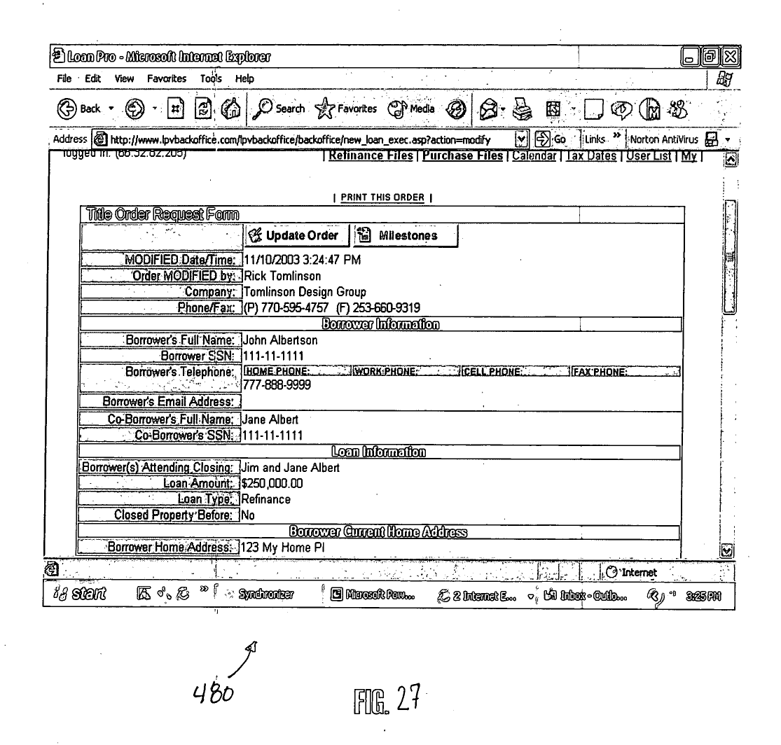

The order may then be submitted to the VTO electronically by the user by selecting a ‘submit order’ button. Thereafter, an order error interface 470 may be provided to the user that automatically identifies errors in the user-input order, as shown in the illustrative example of FIG. 26. This may be executed by the VTO 125 by comparing stored transaction information against the user-input information, and/or by determining if all required fields received appropriate user-input information. After requisite corrections have been made to an order by the user, a summary of the order may be provided via a summary order interface 480, an example of which is shown in FIG. 27. Using the summary order interface 480 the user may select an agent to handle the loan, which may be selected via a drop down list.

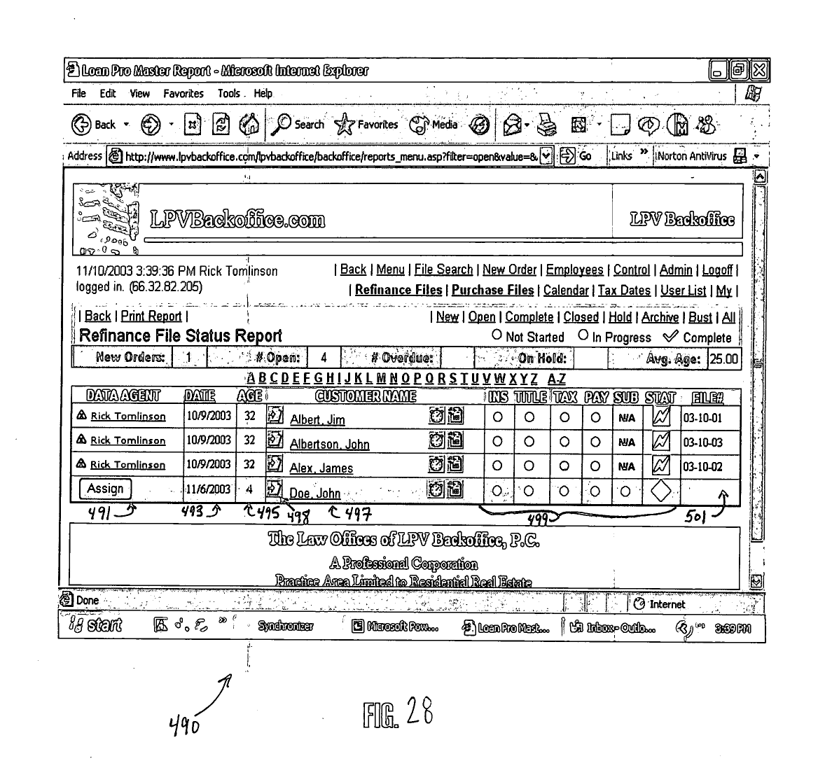

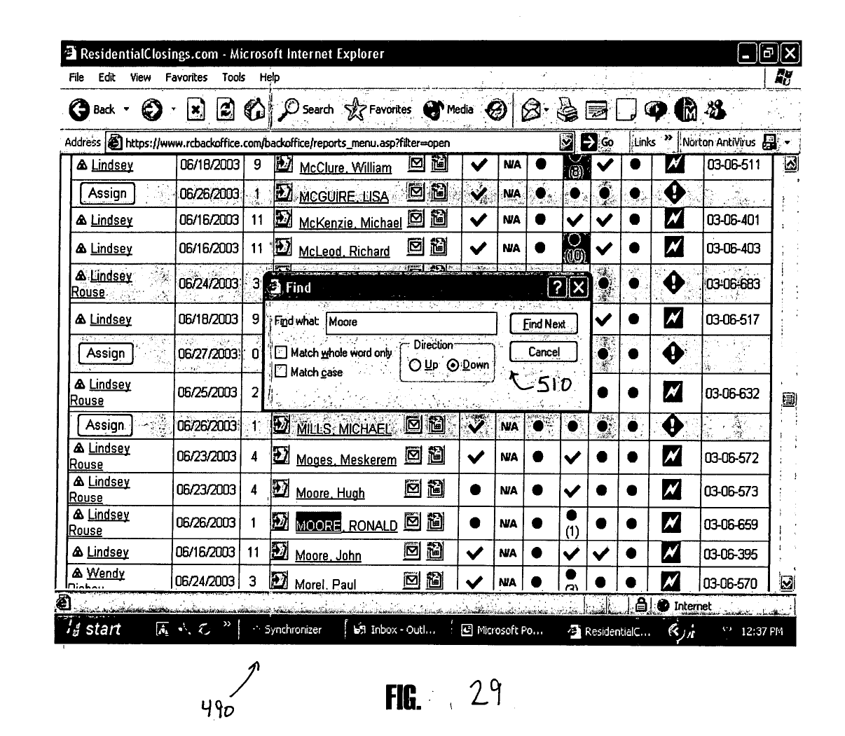

In general, the VTO 125 permits multiple loans to be managed simultaneously by one or more loan officers (or data agents). By selecting ‘refinancing files’ or ‘purchase files’ from the main menu interface 220 of FIG. 4 a user is presented with a file management interface, such as the illustrative file management interface 490 shown in FIG. 28. The illustrative interface 490 shown in FIG. 28 is for refinance files, though it will be appreciated that a similar or identical interface may also be used for purchase files. Generally, using the interface 490 a user may view a summary of his or her files, click on a link to update the customer's information, or check on the progress of one of multiple milestones which include Hazard Insurance, Title Search, Tax Search, Mortgage Payoff, and Subordination. According to one aspect of the invention, the milestones may be viewed simultaneously with indicators or icons to illustrate the status of the milestone. The loan officer can also download documents (ex. Tax search results) using a document manager interface and can print a copy of the title order or the pre-closing check list.

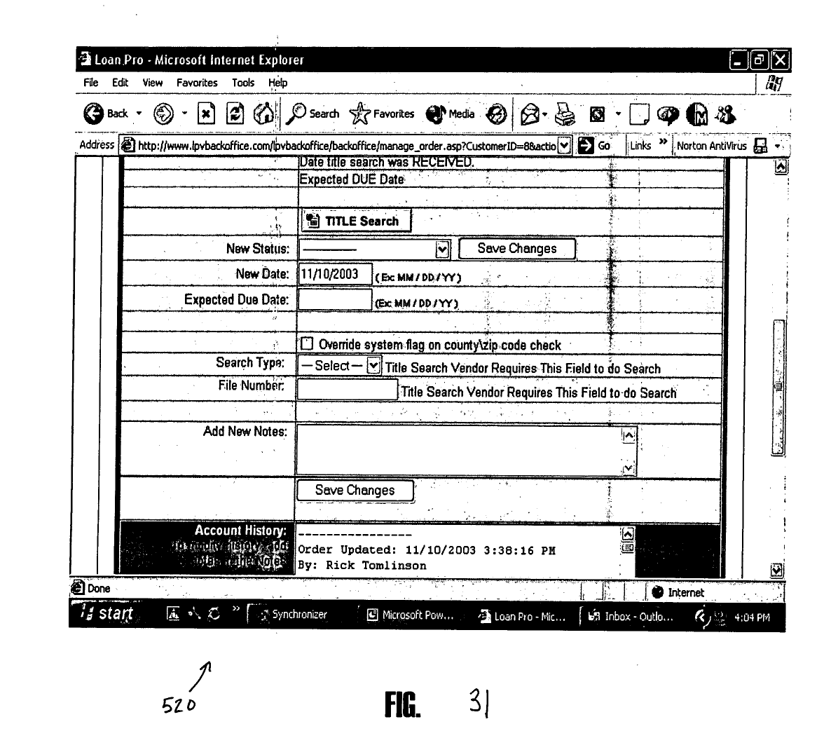

More specifically, the interface 490 displays information specific to each transaction with which the user is associated, including: data agent identity 491, the date the loan order was originated 493, the age of the loan order 495 (e.g., in days), the customer name 497, one or more milestone fields 499, and a file number 501 associated with each loan. A transaction is presented in a single row. According to one aspect of the present invention, each of the above-identified fields are searchable and selectable. An exemplary search tool 510 is shown in FIG. 31, which may utilize features incorporated into an internet browser used to view the interface 490, as is known in the art. For instance, when a specific loan officer's name is selected, those outstanding loans associated with the loan officer may be displayed along with the remaining information specific to the loan. As another example, loans may be ordered based on their age or date. Therefore, each of the columns shown in FIG. 28 may be selected in order to arrange transaction files according to a particular field. For instance, the ‘date’ link may be selected to arrange the transactions according to their age. Clicking on a customer name may also permit the user to update customer information.

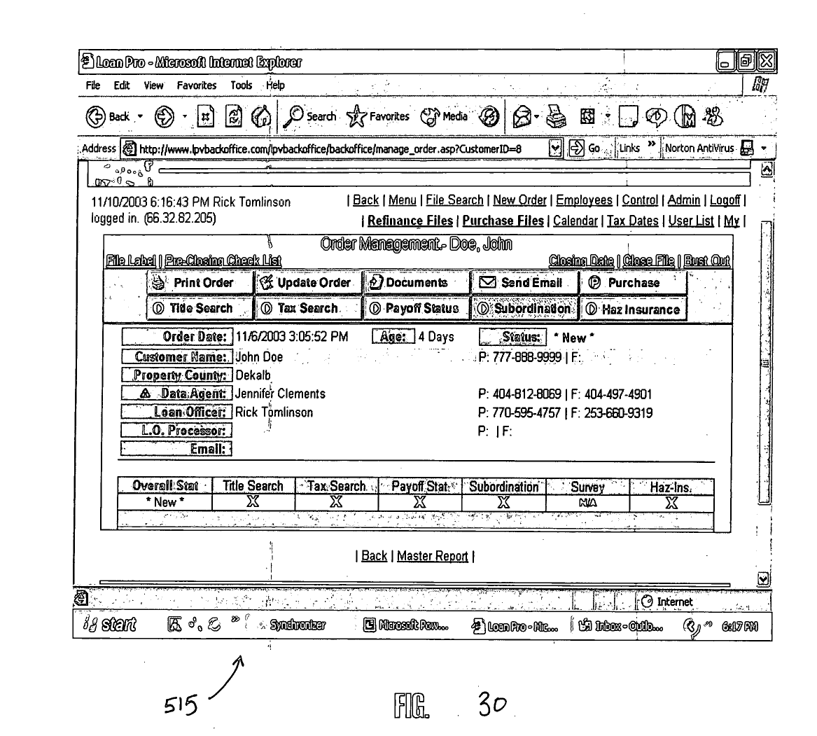

The interface 490 may also include one or more user-selectable icons. That may be selected by a user to initiate one or more processes. For example, when a title icon or box is selected the user may be provided a GUI from which a title search may be ordered. As shown in FIG. 28, an upload icon 498 is provided adjacent to the each customer name to allow a user to upload documents associated with a particular transaction. These documents may be uploaded via a pop-up interface, and the documents may be stored in one or more databases, such as a company database described above with respect to FIG. 2. In FIG. 28 the customer name is also positioned next to a clock icon that may be selected to edit a closing time and/or date, and a calendar icon may be selected to open a milestone manager interface, which is described below with reference to FIG. 30.

The file management interface 490 also includes multiple milestone fields 499 that correspond to the status of a transaction. As shown in FIG. 28, these may include a Hazard Insurance field (‘Ins’), a Title Search field (‘Title’), a Tax Search field (‘Tax’), a Mortgage Payoff field (‘Pay’), a Subordination field (‘Sub’), and a status field (‘Status’). Each of these fields may include a color-coded icon, such as a bullet-point or the like, which indicates the status of a document or documents associated with a field. For instance, where a title search is completed and the results have been uploaded to the VTO 125, the title field may show a green circle. On the other hand, where no work has been done to request the title, the field may show up as a red circle. Other colors may be used, such as yellow or blue to indicate that processing is ongoing. This may occur, for instance, where a title search has been ordered but has not yet been posted to the VTO 125. According to yet another aspect of the present invention, the status field may be used to quickly ascertain the status of a transaction. For instance, this may show whether the loan is on hold, new, incomplete or complete.

Next, an illustrative milestone manager interface is shown in FIG. 30. This interface allows a user to update the milestone fields shown in FIG. 28 and described immediately above. Using the interface 515 a user such as a loan officer can print an order, update an order, upload documents, send an email to a customer or other person associated with the transaction, update purchase information, and update the five milestones: Hazard Insurance, Title Search, Tax Search, Mortgage Payoff, and Subordination. One or more links may also be provided to complete a pre-closing checklist, which may require the user to answer the pre-closing checklist questions 315 provided by a client and described above with respect to FIG. 7.

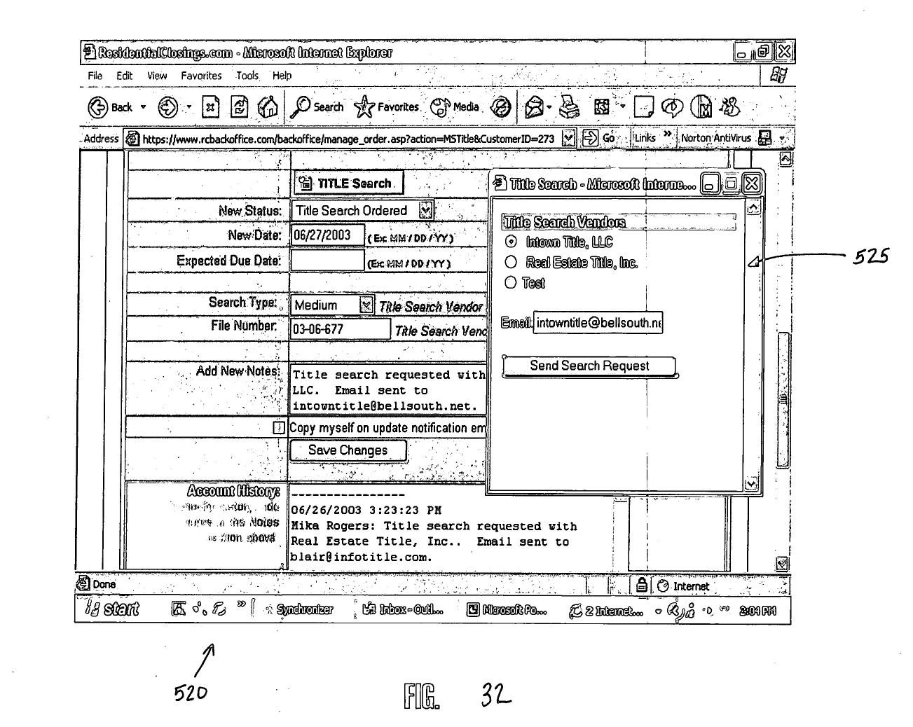

By clicking on the milestone links in the milestone manager interface 515 of FIG. 30, or by clicking on the milestone field icons in the file management interface of FIG. 30, a user may pull up one or more interfaces to enable the user to effect the update and completion of the milestones. For instance, by selecting the title search link in the milestone manager interface 515, or on the title search field in the file management interface 490, a user may be presented with a title search interface, such as the illustrative title search interface 520 shown in FIGS. 31 and 32. Using the interface a user can request that a title search be executed, and can send a search request using an email address 525 that may be automatically associated by the VTO with a selected title search company, which may be selected from a VTO-provided list of companies.

Because the system maintains the record of the real estate at issue in a transaction, the VTO 125 can automatically forward such information to the title searcher. The system will then update the title icon to indicate that a title search was requested. According to an alternative embodiment, the user may also select the status of the icon via a pull down menu provided by a pop-up interface or on the title search interface 525 (not illustrated) after ordering the title. The date of the request may also be stored. Therefore, the system fully automates a process that is otherwise more paper intensive and time consuming.

Upon submitting a request for a title search, the VTO 125 will automatically compare a customer's name and address to a fraud caveat list. If a match is made an error message will be presented to the user and an email may be sent to the administrator to flag the transaction. According to one aspect of the invention, the VTO may not permit any further action to occur until the flag is removed by an administrator. This automated process is a safeguard that prevents a user from closing a real-estate loan using the system where fraudulent information is identified.

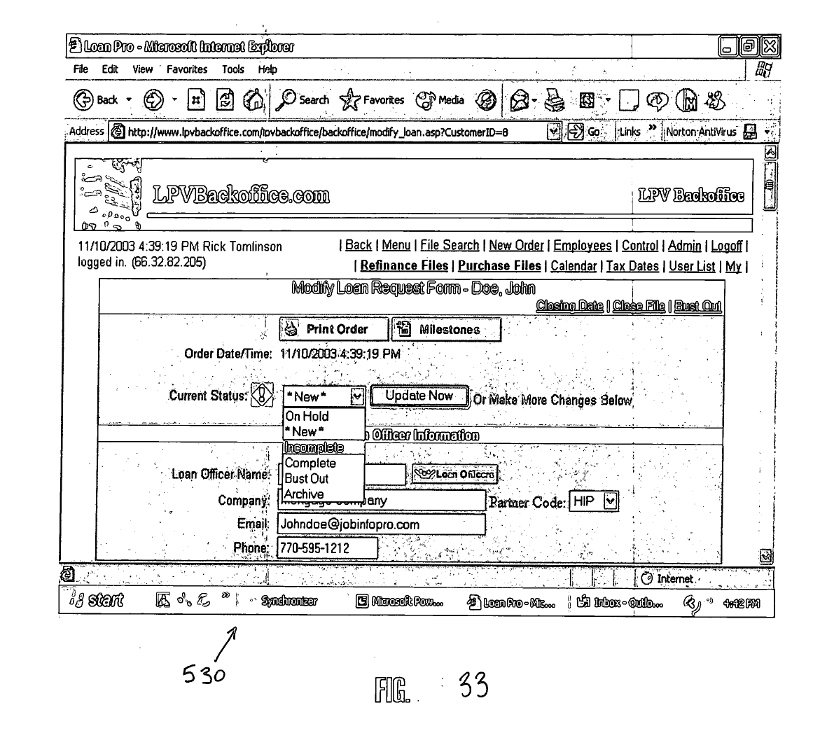

Although not illustrated herein, additional interfaces may be provided for each milestone. Therefore, using these interfaces a user may be able to request a tax search, and may update hazard insurance, mortgage payoff, and subordination information. A user may also download documents (ex. Tax search results) using a document manager interface and can print a copy of each of the documents, as well as copies of the requests electronically submitted by the user using the VTO. Each of these interfaces may automatically update the milestone icons to provide a user with a quick visual indication of these key steps in a real-estate closing transaction. It will be appreciated by those of skill in the art that although Hazard Insurance, Title Search, Tax Search, Mortgage Payoff, and Subordination were used as the milestones in the illustrative examples provided herein, an administrator may configure the milestones for any activity that should be monitored in a transaction. Additionally, a user may also update the current status icon provided in the file management interface 490 by selecting it to access a current status interface, such as the illustrative interface 530 of FIG. 33. This permits a user to change the status of a transaction using a pull down list.

Additional features provided by the VTO 125 permit a user to print all online information related to the loan, and to upload, download and print documents that have been scanned or saved in electronic form. For instance, according to one aspect of the present invention, faxes may be electronically received and automatically saved by the system, after which an operator or the system associates the faxed documents with one or more loans. A master report can be generated by filters based on file status (new, open, complete, closed and on hold), file number, and data agent. The software application also provides multiple reports that track daily progress of each data agent. For instance, the status of each milestone for each open transaction may be monitored and reported on a daily or weekly basis to ensure that the transactions are progressing as required.

In conclusion, because the VTO may be accessed via a WAN or the Internet, users including customers (i.e., lendees) and loan-related parties may access the system. For instance, customers may be able to identify the status of the loan or loan documents. Customers may also be able to upload information, such as loan applications. Third parties such as title searchers and the like may also have access to the system to upload and/or view information.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A real-estate transaction management system, comprising:
at least one server, on which a real-estate transaction application is stored, said real-estate transaction application accessible by one or more users and operable to:
store transaction information related to a real-estate transaction;
identify the status of said real-estate transaction using one or more updateable icons; and
provide one or more interfaces by which the one or more users may view or edit the transaction information or updateable icons.

2. The system of claim 1, wherein said real-estate transaction application is further operable to permit access by said one or more users via a WAN or LAN.

3. The system of claim 1, wherein said real-estate transaction application is further operable to compare the transaction information to a caveat list to identify when said transaction information includes fraudulent information.

4. The system of claim 3, wherein said caveat list is stored on the at least one server.

5. The system of claim 3, wherein said caveat list is remote from the at least one server.

6. The system of claim 1, wherein the real-estate transaction application is operable to receive transaction information provided by the one or more users.

7. The system of claim 1, wherein the real-estate transaction application is operable to display all or part of the transaction information to the one or more users based on respective access rights of the one or more users.

8. A real-estate transaction management system, comprising:
at least one server, on which a real-estate transaction application is stored, said real-estate transaction application accessible by one or more users and operable to:
store transaction information related to a plurality of real-estate transactions, wherein the transaction information is provided by one or more parties to the plurality of real-estate transactions;
identify the status of said real-estate transactions to said one or more users; and
provide a real-estate transaction management interface by which the one or more users can view the status of the plurality of real-estate transactions.

9. The system of claim 8, wherein said real-estate transaction application is further operable to permit access by said one or more users via the Internet.

10. The system of claim 8, wherein said real-estate transaction application is further operable to compare the transaction information to a caveat list to identify when said transaction information may include fraudulent information.

11. The system of claim 10, wherein said caveat list is stored on the at least one server.

12. The system of claim 10, wherein said caveat list is remote from the at least one server.

13. The system of claim 11, wherein the caveat list contains information selected from the group of caveat information including a property address and a purchaser name.

14. The system of claim 8, wherein the real-estate transaction management interface is operable to illustrate the status of the plurality of real-estate transactions using one or more icons.

15. The system of claim 14, wherein the one or more icons are selectable by the one or more users to facilitate the execution of a step to advance one of said plurality of real-estate transactions.

16. The system of claim 15, wherein the real-estate transaction application is operable to display the transaction information to the one or more users based on respective access rights of the one or more users.

17. A method for managing a real-estate transaction, comprising:
collecting transaction information related to a real-estate transaction, said transaction information comprising a property address or a customer name;
storing said transaction information;
making said transaction information available to parties to the real-estate transaction via the Internet;
storing a caveat list, said caveat list identifying fraudulent transaction information; and
identifying when said stored transaction information includes fraudulent transaction information.

18. The method of claim 17, wherein said caveat list is stored local to the transaction information.

19. The method of claim 17, wherein said caveat list is stored remote from the transaction information.

20. The method of claim 17, further comprising the step of updating said caveat information using information received from an entity not a party to the real-estate transaction.
